(19) United States
(12) Patent Application Publication
(10) Pub. No.: US 2014/0321282 A1
(43) Pub. Date: Oct. 30, 2014

(54) HIGH-RATE DUAL-BAND CELLULAR COMMUNICATIONS

(71) Applicant: INTERDIGITAL PATENT HOLDINGS, INC., Wilmington, DE (US)

(72) Inventors: Ravikumar V. Pragada, Collegeville, PA (US); Philip J. Pietraski, Jericho, NY (US); Yingxue K. Li, San Diego, CA (US); Gregg A. Charlton, Collegeville, PA (US); Carl Wang, Melville, NY (US); Arnab Roy, East Norriton, PA (US); Samian Kaur, Plymouth Meeting, PA (US); Douglas R. Castor, Norristown, PA (US)

(73) Assignee: INTERDIGITAL PATENT HOLDINGS, INC., Wilmington, DE (US)

(21) Appl. No.: 14/363,539

(22) PCT Filed: Dec. 7, 2012
(86) PCT No.: PCT/US2012/068565

§ 371 Date: Jun. 6, 2014

Related U.S. Application Data
(60) Provisional application No. 61/568,433, filed on Dec. 8, 2011.

(51) Int. Cl. H04W 28/10

(52) U.S. Cl. CPC H04W 28/10
USPC 370/235

(57) ABSTRACT

A method, apparatus and system for wireless communication are described. The method includes transmitting and receiving data to and from one or more wireless transmit/receive units (WTRUs) via an underlay system access link. The underlay system is non-standalone, and control information is provided from an overlay system. An underlay base station is linked to other underlay base stations to implement a mesh backhaul. The method also includes transmitting and receiving at least a portion of the data to or from an overlay base station via backhaul links and receiving control data from the overlay base station. The data is split at a packet data convergence protocol (PDCP) entity, and the PDCP entity terminates in the overlay base station and a radio link control (RLC) entity terminates in the underlay base station.

### CROSS REFERENCE TO RELATED APPLICATIONS

This application claims the benefit of U.S. Provisional Application No. 61/568,433, filed Dec. 8, 2011, and PCT Application No. PCT/US2012/068565, filed on Dec. 7, 2012, the contents of which are hereby incorporated by reference herein.

### BACKGROUND

The predicable demand for data and the corresponding increase in data delivery capacity has been observed for at least the last 50 years. This demand has come to be known as Cooper's Law, which states that the total capacity will double roughly every 30 months. In order to meet the rapidly growing demand for mobile data going forward, two main synergetic strategies exist.

One strategy includes the use of smaller and smaller cells. This trend has been observed as the main component of Cooper's law, and also is can be traced back to at least 50 years ago. The use of small cells implies an increased spatial reuse of the same spectrum and is considered a conceptually simple approach to achieve greater capacity. A downside may be the cost of the network. As the number of infrastructure nodes grows, the network deployment becomes more expensive. Recently, managing the interference of these dense cells has become another main disadvantage of using small cells. Interference mitigation techniques may be very demanding in terms of complexity and backhaul performance and/or capacity. Thus, further improvements may be limited.

An alternate strategy includes the use of high frequency, large bandwidth (BW) signals. While making use of larger BW has typically been a part of meeting Cooper's Law predictions, additional spectrum has been added at the ‘lower’ frequencies, (below 3 or so GHz). This strategy has had an approximately linear impact on total capacity. However, there is a synergetic effect to be exploited at higher frequencies, for example, spatial reuse. In order to close the link budget for millimeter-waves (mmWs), highly directional antennas are needed and also practical. Further, it makes the transmissions highly contained in the sense that transmitted energy is focused on the intended receiver, (increasing signal), while making it less likely that the transmission will cause interference for unintended receivers. This may lead to a system that is more noise limited than interference limited, which may be ideal for the small cell paradigm.

### SUMMARY

A high-rate dual-band cellular communications architecture utilizing millimeter wave (mmW) and traditional cellular bands is disclosed. A Radio Network Evolution (RNE) architecture for integrating mmW into long term evolution (LTE) architecture is described. An mmW base station (mB) and an mmW gateway node (mGW) are introduced. Integration of low throughput cellular devices to mGWs for mmW management is described and corresponding mechanisms to improve power management at mBs are disclosed. A small-cell cloud RAN including mesh-backhaul is described. A plurality of protocol termination aspects for different nodes in a variety of deployment scenarios is also described. Providing mobile access as well as self-backhaul is also described.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an example tiered architecture for a high-rate dual-band cellular communications architecture utilizing millimeter wave (mmW) and cellular bands;

FIG. 3 shows an example of an evolved Node B (eNB) communicating with mmW base stations (mBs) and wireless transmit/receive units (WTRUs);

FIG. 4 shows an example of a mmW gateway (mGW) along with multiple interfaces;

FIG. 5 shows an example of a WTRU in a radio network evolution (RNE) architecture;

FIG. 6 shows an example of a WTRU protocol architecture;

FIG. 7 shows an example of data splitting at a radio link control (RLC) packet data unit (PDU) level;

FIG. 8 shows an example of data splitting at a RLC service data unit (SDU) level;

FIG. 9 shows an example protocol view of a RLC SDU data splitting method;

FIGS. 10(a)-(c) show example mB deployment scenarios;

FIG. 11 shows an example user plane stack view for deployment scenario 1 with millimeter wave gateway (mGW);

FIGS. 12A and 12B show an example control plane stack view for deployment scenario 1 with mGW;

FIG. 13 shows an example user plane stack view for deployment scenario 1 with no mGW;

FIG. 14 shows an example control plane stack view for deployment scenario 1 with no mGW;

FIG. 15 shows an example user plane stack view for deployment scenario 2 with a Pico cell/Femto cell/relay node;

FIG. 16 shows an example control plane stack view for deployment scenario 2 with a Pico cell/Femto cell/relay node;

FIG. 17 shows an example user plane stack view for deployment scenario 3, (mB as remote radio entity (RRE));

FIG. 18 shows an example small cell cloud radio access network architecture;

FIG. 19 shows an example X3-C protocol view;

FIG. 20 shows an example initiation message sequence;

FIG. 21 shows an example mB buffer status report message sequence;

FIG. 22 shows an example mB-mB handover flowchart;

FIG. 23 shows an example mB-eNB handover flowchart;

FIG. 24 shows an example eNB-mB handover flowchart;

FIG. 25 shows an example TDM mode of simultaneous downlink operation;

FIG. 26 shows an example FDM mode of simultaneous downlink operation; and

FIG. 27 shows an example SDM mode of simultaneous downlink operation.

### DETAILED DESCRIPTION

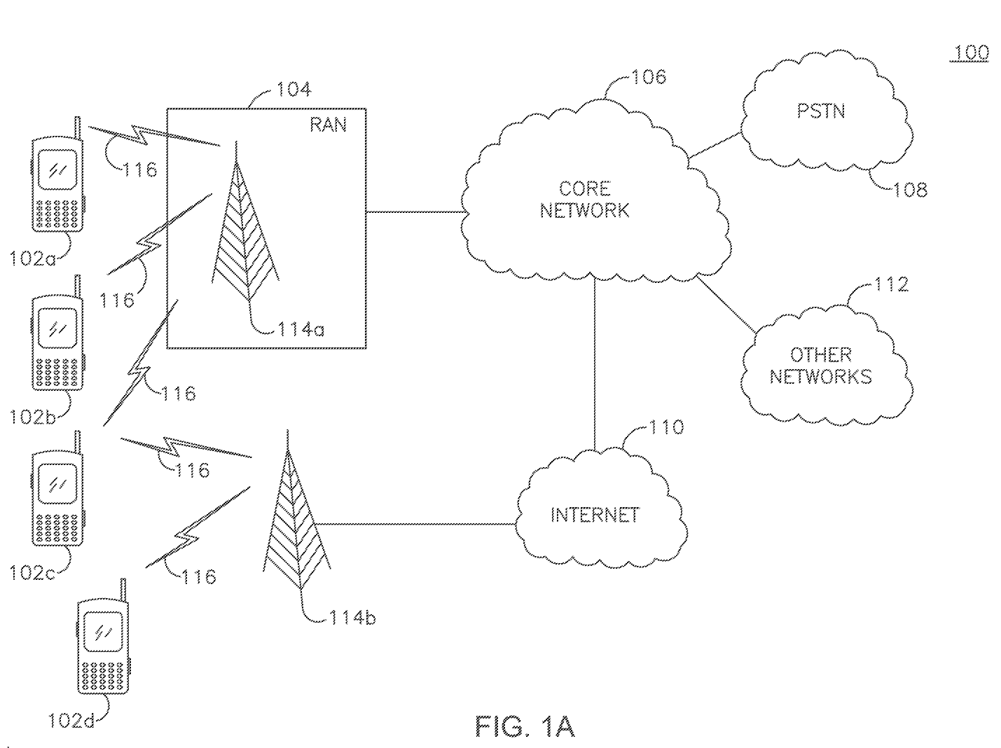

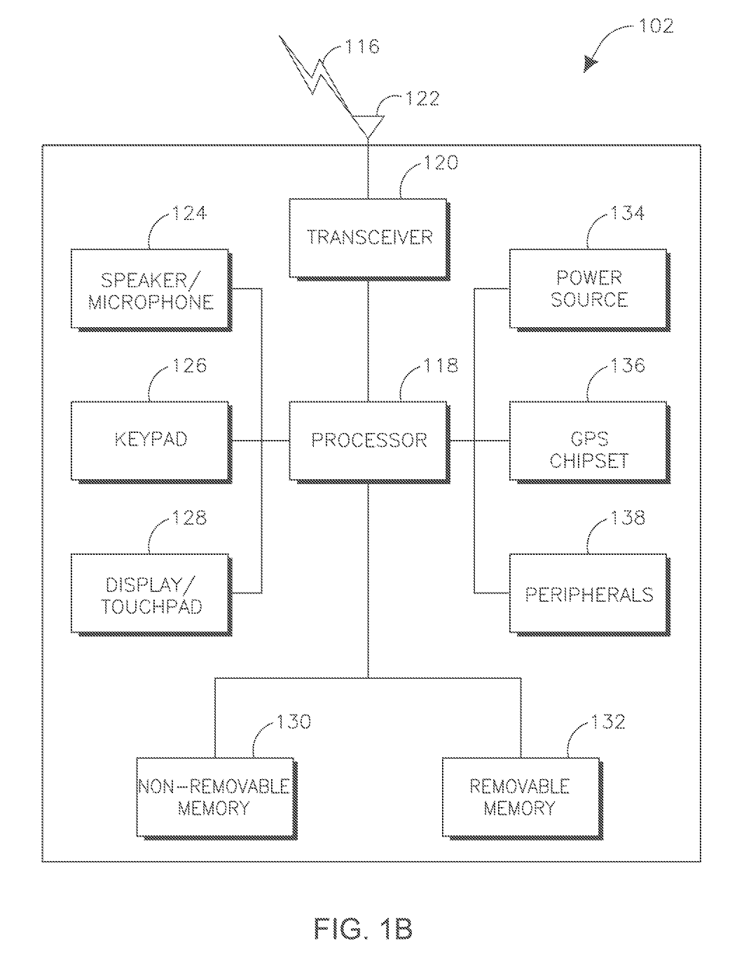

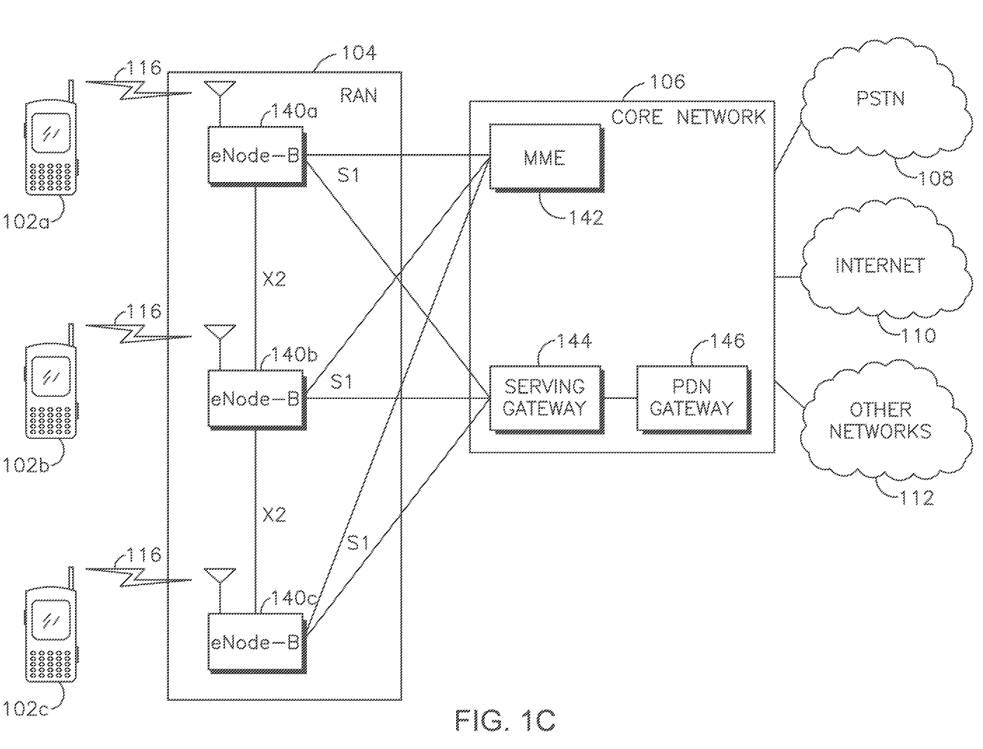

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112.

The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, ITV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

The tremendous growth in demand for wireless services requires breakthrough developments in radio network technology. Previously, network capacity gains have come from spectral efficiency improvement, shrinking of cell sizes, and/or additional spectrum allocations. Traditionally, smaller cell sizes have contributed the most to increased network capacity due to greater spatial reuse of the available spectrum. However this approach faces two problems: increased cost of deployment for more numerous nodes, (corresponding to smaller cells), and more recently, increased interference from adjacent cells due to greater proximity, which negatively affects the received signal-to-interference-plus-noise ratio (SINR).

Moreover, with current link performance already near a limit, techniques to improve spectral efficiency may be complex and offer limited network capacity gains. Additional spectrum availability at low frequencies, (for example, less than 3 GHz), is limited, (less than 500 MHz), and may be inadequate to satisfy bandwidth demands in the future. For example, one study predicts a requirement of 5 GHz of bandwidth in the year 2020 to satisfy the demand for the city of London. This makes the mmW band, (for example, 30-300 GHz), attractive for mobile use for two reasons. First, there is available spectrum, (particularly at lower frequencies), some of which may need regulatory changes. Second, there exists the possibility of spatial containment of the transmitted radio waves at mmW frequencies due to small antennas, which reduces inter-cell interference, thereby allowing closer spacing of nodes.

Accordingly, existing methods of Long Term Evolution (LTE) carrier aggregation are not sufficient to integrate mmW into a cellular layer. In order to aggregate mmW into LTE framework, new architectures and methods are required.

Use of high frequencies is described herein to achieve wide bandwidths and high spatial containment. High frequencies offer the potential of wide bandwidths and the narrow beamforming enabled at these frequencies, (along with high penetration losses), may provide a high spatial containment of transmitted signals. These frequencies are referred to as millimeter wave frequencies, or simply mmW. The precise frequency range is not defined, but frequencies in the range of about 28 GHz to 160 GHZ, (or even 300 GHz), may be used with a special interest in the unlicensed V-band (60 GHz band) and E-band (70/80/90 GHz point-to-point band). Even higher frequencies, (sometimes referred to as THz), may also be used.

The V-band is of particular interest due to the approximately 7 GHz (depending on country) of unlicensed spectrum available and the growing ecosystem of under-development standards such as WiGig, WirelessHD, and the like. The E-band may also be of interest due to the light licensing structure wherein a point-to-point license could be purchased online at a reasonable price and could be suitable at least for the backhaul, and potentially for access links with modifications of existing rules.

To further improve achievable throughput and coverage of LTE-based radio access systems, and in order to meet the International Mobile Telephony (IMT)-Advanced requirements of 1 Gbps and 500 Mbps in the downlink (DL) and uplink (UL) directions respectively, several LTE-Advanced (LTE-A) concepts were introduced into the Third Generation Partnership Project (3GPP) including carrier aggregation (CA) and the support of flexible bandwidth arrangement features. The motivation was to allow downlink (DL) and uplink (UL) transmission bandwidths to exceed, for example, 20 MHz, 40 MHz, or even up to 100 MHz. In LTE-A, component carriers (CC) were introduced to enable the spectrum aggregation feature.

A WTRU may simultaneously receive or transmit one or multiple CCs depending on its capabilities and channel availability. An LTE-A WTRU with reception and/or transmission capabilities for CA may simultaneously receive and/or transmit on multiple CCs corresponding to multiple serving cells. An LTE WTRU may receive on a single CC and transmit on a single CC corresponding to one serving cell only. CA may be supported for both contiguous and non-contiguous CCs with each CC limited to a maximum of 110 Resource Blocks in the frequency domain using the LTE numerology. It is proposed that there will be up to 100 MHz aggregated spectrum, with 20 MHz max bandwidth for each CC, and therefore at least 5 CCs.

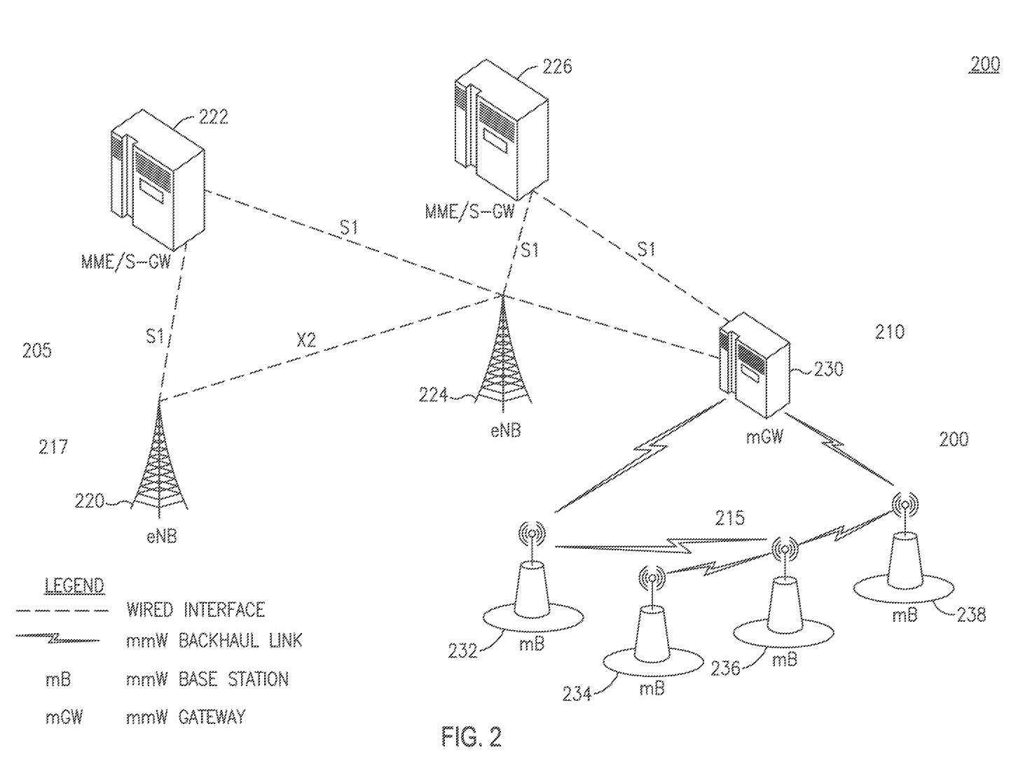

Described herein is a Radio Network Evolution (RNE) architecture that enables integration of mmW frequencies or other higher order frequencies, (as further described herein below), into a cellular system. This is achieved by having a cellular overlay with an mmW underlay as illustrated in the example tiered architecture 200 shown in FIG. 2. The tiered architecture 200, for example, includes cellular systems 205 and 210 overlaid with mmW systems 215 and 217. Cellular system 205, for example, includes an eNB 220 in communication with a MME/S-GW 222 and cellular system 210, for example, includes an eNB 224 in communication with a MME/S-GW 226. The MME/S-GW 222 is also in communication with the eNB 224, which is also in communication with the eNB 224. The mmW system 215, for example, includes a mmW gateway (mGW) 230 which is in communication with mmW base stations (mBs) 232, 234, 236 and 238.

Although the description herein is with respect to mmW frequencies, the architecture and methods below are also applicable to integrating a non-standalone underlay layer operating on existing LTE frequencies, (meaning sub 6 GHz cellular frequency channels) or on other higher order frequencies, (for example, but not limited to, 3.5 GHz), with a cellular overlay system, such that the cellular system provides the required control framework and the underlay layer provides “large data pipes” for carrying high throughput data.

The mmW underlay layer is not expected to operate in a stand-alone fashion. The cellular system is expected to provide the required control framework including all control signaling such as system information, paging, random access channel (RACH) access, radio resource controller (RRC) and non-access stratum (NAS) signaling (signaling radio bearers) and multicast traffic is provided via the cellular layer. While the mmW layer may be used as the default for high throughput traffic, low throughput and delay sensitive traffic may also be carried by the cellular overlay layer.

An mmW capable WTRU may first be connected to the cellular layer before it can receive data on the mmW layer. The WTRUs are envisioned to have either mmW DL only capability, or have both UL and DL mmW capabilities. All WTRUs continue to have both UL and DL cellular capabilities. The cellular layer is used for mmW network control, connectivity and mobility management, and carries all L2/3 control messages thus alleviating the mmW layer from the costs of these functions.

The mmW layer may be integrated into an existing cellular system such as LTE using carrier aggregation concepts that were introduced in 3GPP Release 10. The mmW frequencies may be seen as secondary carriers. With the introduction of mmW, non co-located carrier aggregation concepts may have to be explored if mmW processing is handled in a node which is physically separate from the eNB. This is achieved by introduction of a new node as described herein below. The protocol stack architecture depends on deployment scenarios and is further described herein below.

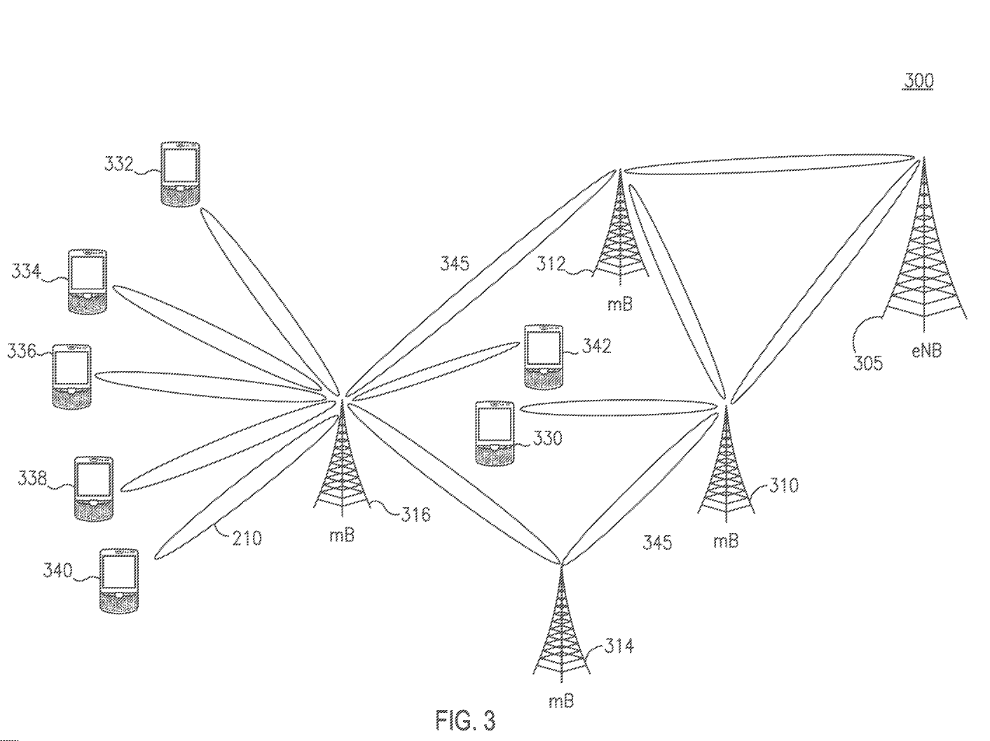

FIG. 3 shows another example of an RNE architecture 300 that highlights the mmW layer and associated links. The RNE architecture 300 may include an eNB 305 in communication with multiple mBs 310, 312, 314 and 316. The mBs 310, 312, 314 and 316 may have backhaul (BH) links 345 to each other. The mmW links for BH may not reach from every mB to the eNB 305. The BH links 345 may form a multi-hop mesh network such that long links are not required, and reliability may be achieved via multiple links. The mB 310 may have an mmW access link to WTRU 330 and the mB 316 may have an mmW access link to WTRUs 332, 334, 336, 338, 340 and 342.

With the exceptionally high data rates that are expected to be supported with the introduction of the mBs, the eNB would be burdened with control plane, access stratum processing and routing of this data. To alleviate this problem, another logical node called an mGW is introduced to forward user data to the mmW layer. The mGW node is a logical entity and may be co-located with the eNB, mB or may exist as a separate physical entity. The mGW is responsible for routing and access stratum (AS) processing of user data that is carried over the mmW underlay. The S1-U interface from the serving gateway (S-GW) in evolved packet core (EPC) is extended to the mGW node. The S-GW may now provide an S1-U interface to both the eNB and mGW, but the S1-C interface may only exist between the eNB and MME. In an example, the S1-C interface may also be supported between the mGW and the Mobility Management Entity (MME). A new interface, called the M1 is introduced between the mGW and eNB. This interface provides control and management functionality required for the eNB to control the scheduling and data processing at the mGW.

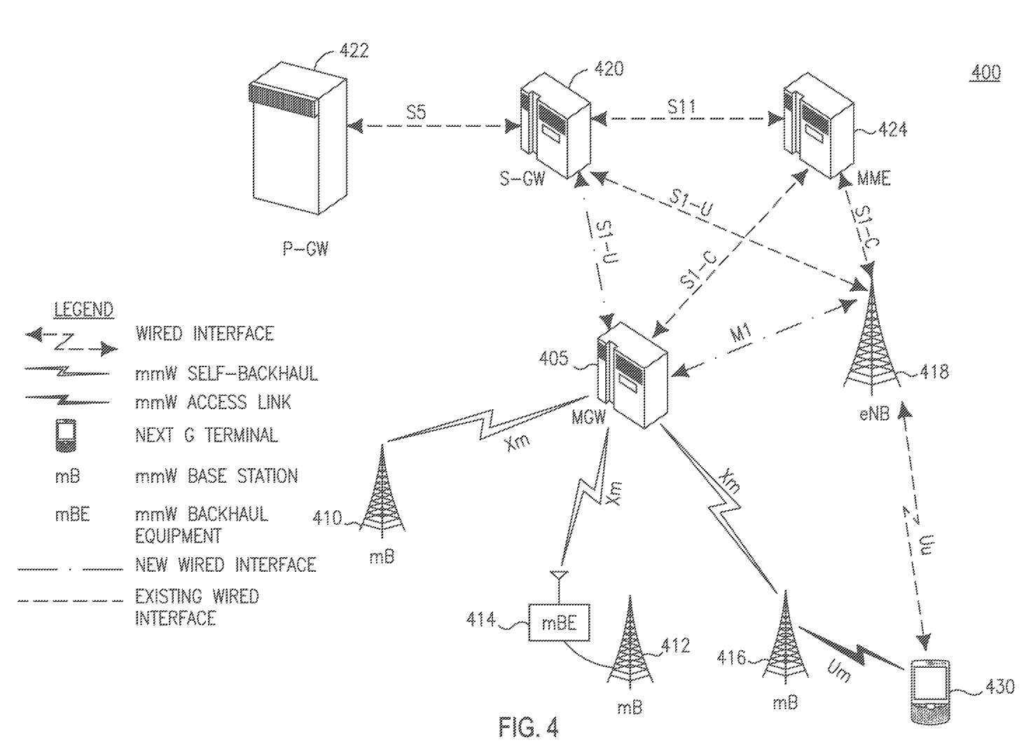

FIG. 4 shows an example system 400 with an mGW 405 and related interfaces/links as described herein above. The mGW 405 may be in communication with an mB 410 over an Xm link, a mB 412 via a mmW backhaul equipment (mBE) 414 via an Xm link, a mB 416 via an Xm link, a eNB 418 via a M1 link and a S-GW 420 via a S1-U link, which in turn may be in communication with the eNB 418 via a S1-U1 ink, a P-GW 422 via a S5 link and a MME 424 via a S11 link. The MME 424 may also be in communication with the eNB 418 via a S1-C link. A WTRU 430 may be in communication with the mB 416 via an Um link and the eNB 418 via an Uu link.

Described herein is the mesh backhaul. With dense deployments, it may not be feasible to roll out fiber to provide backhaul for each mB and an mmW backhaul may be used to alleviate the need for fiber rollout. The mBs are connected to the mGW node by means of the mmW backhaul. The high directionality of the mmW beam implies that there could be a lot of spectrum reuse. The same spectrum may be used for both mmW access and mmW backhaul, (the term mmW backhaul mmW self-backhaul may be used interchangeably). The mBE is responsible for providing mmW connectivity over the backhaul for the mB. The mBE may be separate from the mB itself as shown in FIG. 4. The mBE may be deployed at a position where it has better line of sight (LOS) to another mBE. Based on availability, mBs may also be connected via other wired backhaul technologies such as fiber to mGW.

The cost of the backhaul mmW link increases substantially with range. In order to bring down the cost and complexity of mmW backhaul links, mesh backhauls may be used. The non LOS (nLOS) nature of mmW links may also benefit from usage of multi-hop mesh links. For mesh backhauls, the mmW links for backhaul are not all expected to reach from every mB to the mGW or eNB. Each mB is also expected to be able to reach one or more neighboring mBs using backhaul links. The backhaul links between different mBs themselves and between certain mBs and mGW nodes form a multi-hop mesh network so that long backhaul links are not required, (thus reducing capital expenditure (CAPEX)), and backhaul reliability may be achieved via multiple links.

The mesh backhaul on the mmW layer may extend far from the eNB and may require more than one hop. There may also be a large number of mBs that could be within the range of another mB, thus providing the possibility of many routes and also the ability to use advanced techniques such as Network Coding (NC). Clearly, the presence of a LOS path on each backhaul link is beneficial. However, the support of limited nLOS is also required. This is accomplished by steering beams around lossy obstructions, for example, people. Such a transmission may not have the large delay spread of the usual nLOS channel since there may not be many reflectors in the beamwidth of the antenna arrays. However, a substantial additional pathloss needs to be considered. The links between mB may be better than the access links due to several reasons such as: 1) both the transmitter (Tx) and receiver (Rx) have larger antenna arrays; 2) some amount of minimal planning may have been used when installing an mB; and 3) beam tracking is simpler for stationary targets.

The mmW backhaul links need not be static as in traditional cellular systems. The mesh backhaul provides several alternative routes and if an mmW backhaul link needs to be established dynamically, it can be setup on the fly. The low throughput cellular link used for mB to eNB management may also be utilized for this coordination between mBs for faster link acquisition between the nodes where a mmW backhaul link has to be established.

Backhaul links may be made of several technologies such as mmW backhaul, fiber and the like. Each backhaul link provides its attributes or capabilities to the backhaul routing protocol. Mesh backhaul routing protocol (MBRP) is collectively aware of the state of the each of the backhaul links in the system along with their attributes. The MBRP design may be less complex than classical ad hoc routing protocols as the mBs and mGW nodes are stationary. The dynamic elements are the link metrics such as load, ability to support a given latency and the availability of the link itself. The MBRP may utilize some sort of link state routing protocol to handle the dynamic nature of the link metrics. Other criteria for MBRP may also be to reduce the number of hops on the backhaul. Ultimately, the MBRP has the responsibility to determine the route required for supporting a given quality of service (QoS) and it takes the dynamic nature of the link metrics into account. It may also request establishment of mmW backhaul links as required for supporting a given QoS.

Described herein are definitions and capabilities of the RNE architecture nodes. The millimeter wave base station (mB) provides mmW access links to the mobiles and mmW backhaul links to other mBs and to the mGW node. The mBs also maintain a control interface to the cellular base station (eNB). The cellular base station is responsible for providing management functionality to the mBs. In order to control the mBs, a low cost cellular device such as LTE-lite, (M2M version of LTE), may be integrated with the mB. The eNB and the mBs use this low throughput cellular link for management purposes. This low throughput link also enables mBs to better utilize power save mode. The mBs may potentially turn off their mmW transceivers both for backhaul and access if they are not currently servicing any users. The low throughput cellular link is always available for the eNB or other mBs to reach a particular mB. The mB can always turn on its transceiver either for backhaul alone, or for both access and backhaul as required.

The mBs are expected to perform mmW physical layer and may perform mmW MAC layer functionality. They may include radio link control (RLC) and packet data convergence protocol (PDCP) layers as well. Apart from mmW data processing, mB is also expected to perform scheduling related functions for mmW frequencies that are assigned to this mB by the eNB. The mB may also be able to respect different QoS grades and WTRU classes. The mBs must be capable of mmW transmissions in DL and mmW reception in UL. The mB may be capable of receiving mmW feedback information. The mBs are also responsible for providing grant information to users that are currently associated with that mB, for both mmW DL and UL frequencies that they operate in. The mBs also terminate the mmW BH link protocol. These mmW backhaul links may be connected to other neighboring mBs or in some cases may be directly connected to the mGW node.

The mBs do not need to be discovered and measured by WTRUs without direction from the cellular layer, nor would it be easy for them to do so. In the tiered RNE architecture, a WTRU stays connected to the mmW underlay layer when it is receiving high throughput services via the mmW layer. Therefore, the mmW link is maintained only for the duration of the high throughput data service. Whenever high throughput data services have to be provided via mmW layer, an mmW acquisition procedure has to be performed by the network to establish a mmW link for the target WTRU.

A truly cellular concept does not exist for such a mmW layer. A WTRU does not perceive its signal strength to be higher due to proximity alone. Neither does it perceive interference from other mBs as due to proximity alone. The high directionality of the beams implies that transmitted signals must be pointed in the direction of a receiver to be perceived, (either as a strong signal or interference). The phenomenon is extended when the directionality of the receiver antenna is considered. For a dense network of mBs in a complicated terrain, the notion of a cell boundary is lost since there may be large regions where multiple mB could be suitable serving nodes for a WTRU.

For wide acceptance of mBs, it is imperative that the mB costs be kept low. These include both CAPEX and operational expenditure (OPEX). Critical aspects for cheap mB deployment and maintenance are self-organizing networking (SON) concepts such self-configuring, self-optimization and self-healing. The low throughput cellular link between mBs and the eNB play a key role for enabling SON for the mmW layer. The outdoor mB units are expected to be small, light-weight and “belt-able” for easy installation. They can be pole mounted to existing street lamp posts and do not require air-conditioning or indoor housing. Their low energy needs may also enable power-over Ethernet (PoE) feeding.

When an mB is newly deployed, using the low-throughput cellular link, the mB contacts the eNB and may provide its geographical location information. The eNB may then query its database for other mBs that are in the proximity of this mB. The newly deployed mB uses this information as a starting point to identify its neighbors similar to automatic neighbor relation (ANR) in existing cellular systems. The eNB after learning about the capabilities of this newly deployed mB, may also coordinate with the neighboring mBs to enable the establishment of backhaul links between these mBs. The techniques for backhaul link acquisition may be similar to the access link but may be much more simplified as the mBs are stationary. In order for initial configuration of the system parameters, these neighboring mBs may provide information to this newly deployed mB. The newly deployed mB may use this information in a docitive fashion to determine the initial set of system parameters for its operation. These mBs may also periodically exchange system parameters for self-optimization and load balancing reasons.

The mGW node is responsible for executing higher layer data plane functionality for mmW traffic. It reduces the burden on the eNB by eliminating the need for routing and data plane processing for high throughput data carried over the mmW underlay layer. The mGW node also terminates the mmW backhaul to one or more mBs. The S1-U interface from the S-GW is extended to the mGW so that user data that is carried over the mmW underlay layer does not need to go through the eNB.

The mGW node interfaces with the eNB using the newly introduced M1 interface as shown in FIG. 4. The two sub-components of the M1 interface are a M1-C for control and a M1-U for user plane data interfaces. The M1-C provides a management interface so that the eNB may still retain complete control over mmW layer processing. The S1-C interface is still terminated at the eNB. All functionality related to bearer establishment, re-establishment and deletion is still handled by the eNB.

In one embodiment, the mGW node removes the need for access stratum security keys to be distributed to each of the mBs. It also enables minimal data loss during handovers for the mmW underlay layer. This is achieved by terminating the RLC layer at the mGW where automatic repeat request (ARQ) is implemented and the data is typically buffered. This also avoids the need for data forwarding between mBs during handover and still achieves lossless handover as long as the mBs are connected to the same mGW node. If the WTRU moves from one mGW to another mGW node during handover, data has to be forwarded at the PDCP layer similar to how it is done in a baseline LTE system. The mGW nodes interface with each other via the M2 interface. The M2-interface may be mmW backhaul based or could be a wired interface. If the M2 interface is implemented using mmW backhaul links, there may be several hops from source mGW to target mGW via several mBs. It is the responsibility of the routing protocol to determine the best route based on QoS requirements of the data being forwarded.

A mmW capable WTRU may either have mmW DL only capability, or have both UL and DL mmW capabilities. The WTRUs with mmW DL only capability, may send feedback information via the cellular system to the eNB. The eNB may then forward this information to the mB that is currently supporting the corresponding WTRUs.

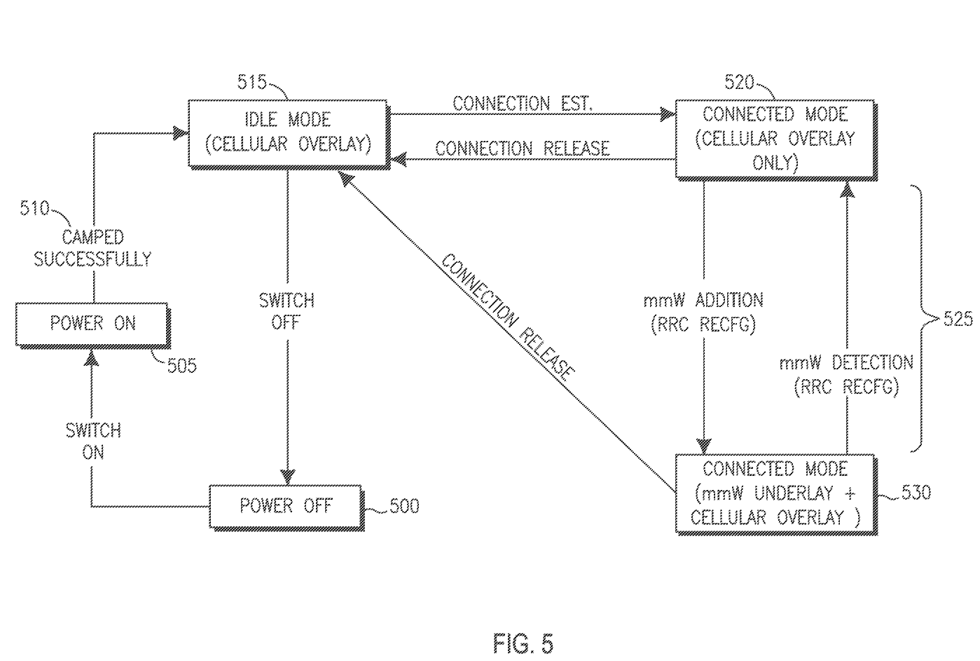

FIG. 5 shows an example life of a WTRU in RNE and how WTRUs obtain mmW connectivity. As described herein above, an mmW capable WTRU connects to the cellular layer before it connects to the mmW underlay layer. The eNB is still responsible for all RRC processing including an mmW underlay layer specific configuration. The eNB coordinates with the corresponding mB that the UE connects to.

Upon power on (505) from a power off mode (500) and successful camping on a cellular layer (510), the WTRU moves to Idle mode (515). Even if the WTRU is looking only for mmW layer services, it first has to go through a RACH procedure using the LTE baseline system and move to connected mode (520). At this point, the eNB, after consideration of the mBs that are involved, will determine the suitable mB for the WTRU to connect to and will provide the required mmW specific configuration information to the WTRU via RRC procedures, (mmW Addition using RRC reconfiguration or equivalent messages) (525). The WTRU will then move to a connected mode with an mmW underlay and a cellular overlay (530). Once the WTRU is done with mmW services, the WTRU can either move directly to Idle mode if it is currently not utilizing any cellular underlay services (515) or it may move to connected mode with only cellular underlay services (mmW deletion) (520). The WTRU Idle mode mobility only pertains to the cellular layer and is no different from the LTE baseline system.

The WTRU may be provided with security mode commands similar to the LTE baseline system. As mentioned earlier, the PDCP layer where ciphering and integrity protection algorithms are executed is oblivious to whether the cellular layer or the mmW layer carries its data. Even during handover from one mB to another mB, as long as they are associated with the same mGW and eNB nodes, the same security keys could be maintained for the user-plane data on the mmW layer, as the PDCP layer is terminated at the mGW. As long as the mGW node does not change during mB handover, it is reasonable to assume that there is no need for updating the security keys. If the mGW changes during handover, then security keys are updated in a fashion similar to how it is handled during eNB handover in an LTE baseline system. The WTRU might be required to maintain different discontinuous reception (DRX) cycles and different sets of criteria for going into short or long DRX modes for the cellular underlay and the mmW underlay.

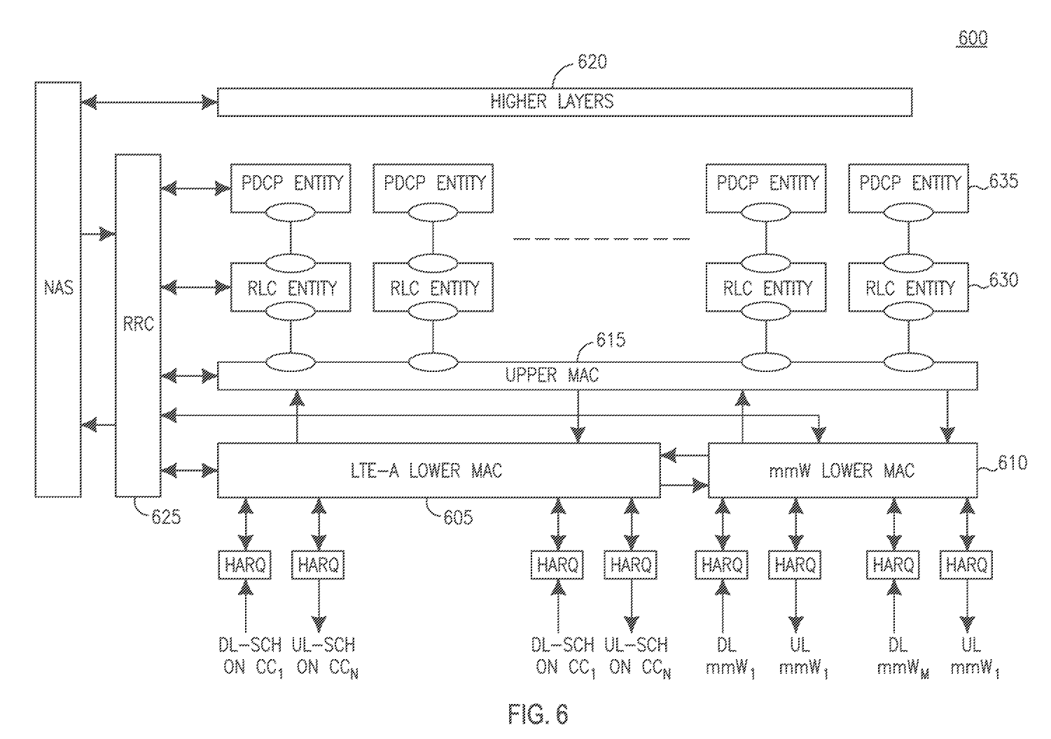

FIG. 6 shows a WTRU protocol architecture 600. The WTRU protocol architecture 600 involves tight integration between the mmW and cellular layers. A mmW lower MAC layer 605 is tightly coupled to a LTE-A lower MAC layer 610. An upper MAC layer 615 is common to both mmW and LTE and is transparent to higher protocol layers 620. A RRC layer 625 is still responsible for configuring and controlling the mmW lower MAC layer 605, LTE-A lower MAC layer 610 and physical layers. The RLC layer 630 and PDCP layer 635 are not exposed to whether the cellular underlay system or the mmW underlay system is utilized for transmission and reception of data. This is in line with the LTE Release 10 carrier aggregation framework. The upper MAC layer 615 provides consistency and hides these details from the RLC layer 630 and the PDCP layer 635.

Several flavors of logical channel prioritization (LCP) may be used depending on the deployment and application scenarios. For example, combined LCP may be used. In this version of LCP, logical channel prioritization is performed across all logical channels at the cellular transmission time interval (TTI) interval rate. The combined LCP algorithm ensures that data is prioritized irrespective of which underlying RAT the data is carried on. At each cellular TTI, a combined LCP algorithm is invoked. Grants for cellular underlay layer and mmW underlay layer must be available at this point for combined LCP execution. Even though the mmW layer specific TTI may be much smaller than the cellular layer TTI, (it is expected that the mmW layer TTI will be a fraction of cellular layer TTI), a combined LCP algorithm determines how much data corresponding to each radio bearer, (or logical channel), will be transmitted on the cellular underlay layer versus the mmW underlay layer.

In another example, split LCP may be used. In this version of LCP, logical channels are either mapped to the cellular underlay layer or mmW underlay layer, but not both at the same time. In other words, certain traffic, (identified by specific logical channels), is mapped to be carried over the mmW layer at RRC configuration time. This mapping does not change on a TTI basis, but is allowed to be updated on a much coarser scale, for example, using RRC (re)configuration messaging.

Cellular lower MAC performs LCP similar to a baseline LTE system for the logical channels that are mapped to the cellular underlay system. The mmW underlay layer performs LCP based on the logical channels that are mapped to the mmW underlay layer. This LCP for the mmW underlay layer is executed in the upper MAC using data from each logical channel, (for example, buffer occupancy, service data unit (SDU) sizes and the like), and logical channel priority information provided during configuration along with mmW underlay layer specific grant information.

In another example, hybrid LCP may be used. In this version of LCP, the cellular underlay layer stack first executes its LCP to satisfy prioritized bit rate (PBR) requirements for all logical channels in that TTI and also maximum bit rate (MBR) for some channels to the extent that the cellular underlay layer grant allows it. The rest of the MBR data for each of the remaining logical channels is provided to the mmW underlay layer for transmission. The mmW underlay layer performs LCP for the MBR data for the logical channels it is provided with in that time interval. This version of LCP could lead to out-of-order packet arrival at the receiver and since RLC supports out-of-order reception, this may not be an issue.

Alternatively, if the WTRU supports mmW DL only capability, then all of the feedback from such a WTRU is sent to the eNB using LTE channels, (sub 6 GHz channels). The eNB will then have to forward this feedback information to the corresponding mB via the backhaul. This may introduce additional delay due to the processing and transmission time required at the eNB and backhaul that needs to be accounted for when allocating these resources over the DL.

The eNB is responsible for management and control of the mBs. The eNB provides management functions required for mB operation such as which users are allowed to connect to the mB, what configuration is utilized by each mmW capable WTRU including QoS of the data being mapped to the user, mmW capabilities of the user, WTRU class and similar other information required for proper operation of the WTRU to mB mmW link. The eNB is responsible for providing mmW configuration to the WTRUs using RRC procedures and configuration messages. It may also broadcast mmW specific information that is pertinent to the mBs for which it is responsible.

The eNB also assists in load-balancing between several mBs for which it is responsible. The eNB is also in control of WTRU handover from one mB to another mB. The eNB also performs radio resource management (RRM) functions for mmW frequencies and provides mBs with information such as which mmW frequencies are allocated for each mB based on each mB's capabilities and other RRM factors. Scheduling decisions on a TTI by TTI basis are performed at each mB.

The eNB to specific mB association is not static. Since mesh backhaul avoids the need for direct physical connectivity between the mB and the eNB, a mB may be associated with an eNB that is not closest geographically. A specific mB may be associated with more than one eNB simultaneously. The eNB is also responsible for establishment of security procedures for the mmW layer. The eNB provides required access stratum security keys to the mGW nodes. All mGW nodes are assumed to be trusted devices. The mBs are not required to be trusted as only ciphered and integrity protected data, (if ciphering is enabled), is sent to each mB.

Described herein are data splitting approaches. Data splitting may be performed in the network at different levels. The higher-layer data plane layers such as RLC and PDCP may be present at either the eNB or the mGW nodes. In the descriptions below, the eNB and mGW are used interchangeably when describing placement of higher layer data-plane layers.

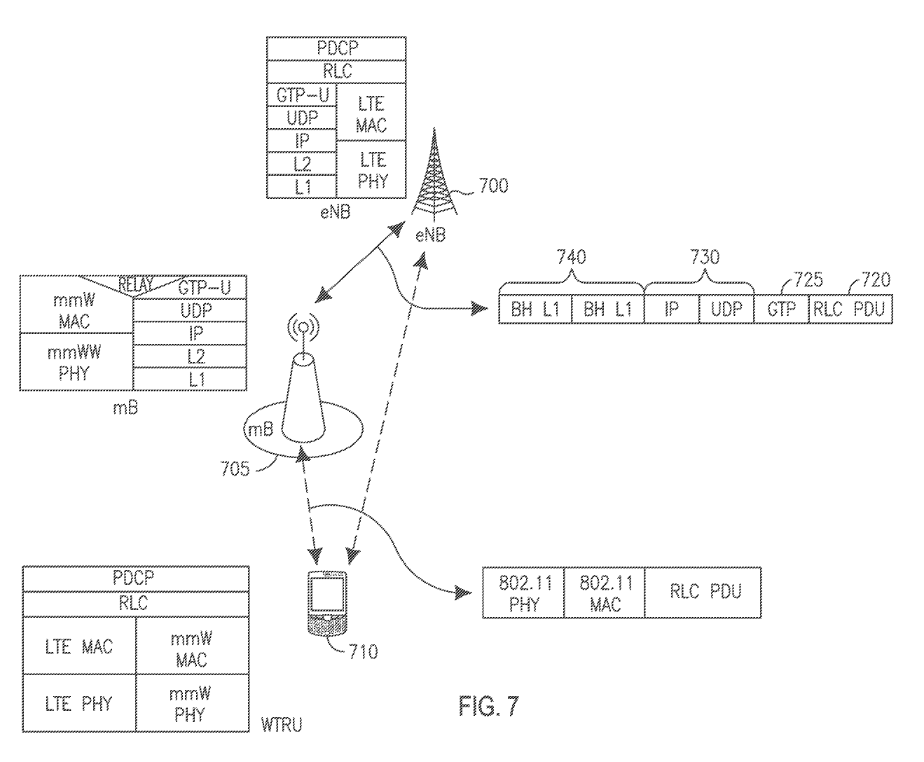

FIG. 7 shows an example of data-splitting using a RLC protocol data unit (PDU) approach. A eNB 700 is in communication with an mB 705 and a WTRU 710. In this approach, the RLC and PDCP entities terminate in the eNB 700 and the WTRU 710. Although the eNB 700 is used in this description, it is applicable to an mGW. The mB 705 executes mmW physical layer and mmW MAC layer functionality and provides support for backhaul links. The backhaul link could be based on mmW technology or any other technology such as a microwave link, any wired or fiber link, metro Ethernet or gigabit Ethernet link and the like.

The RLC protocol data units (PDUs) 720 or MAC service data units (SDUs) are embedded into general packet radio service (GPRS) tunneling protocol (GTP) 725 which runs over user datagram protocol/Internet Protocol (UDP/IP) 730 over the backhaul link 740 between the eNB 700 and the mB 705. The RLC PDUs 720 are transmitted between the mB 705 and WTRU 710, and the eNB 700 and the WTRU 710 over user-plane connections, i.e. the 802.11ad MAC and PHY, and the LTE MAC and PHY, respectively.

The eNB can perform the data-split based on the real-time condition information about the LTE channels, (meaning sub 6 GHz cellular frequency channels), and real-time information about mmW channels within a particular flow, i.e., for a logical channel or data radio bearer. In this case, the same flow is split across the LTE channels and the mmW channels. Alternatively, mmW channel information may be averaged at the mB over a period of time, for example several TTIs and be sent to the eNB for signaling efficiency over the backhaul links, where averaging is just one example but any other means known to one skilled in the art may also be utilized, such as differential methods and the like

The mB may also provide data such as typical MAC PDU size that it is able to transmit in a specific interval. This will enable the eNB to determine the RLC PDU size that it should create for transmission over the mmW links. This reduces the need for further segmentation and/or concatenation at the mB. In certain circumstances, when the link conditions change dramatically at the mB in a very short duration, the mB may perform segmentation (or concatenation) for more efficient use of the mmW spectrum. This could also be done when mmW link conditions do not allow the same RLC PDU size to be transmitted over the mmW link and the data has to be segmented. If PDCP discard handling has to be supported, the signaling required may also be sent over the backhaul link.

The data may also be split across the logical channel level for example, when the mGW node is utilized. In this case, the entire flow (i.e. data radio bearers (DRB)) is either mapped to the LTE channels or the mmW channels, but not both at the same time. Of course, logical data split may also be used when there is no mGW node involvement.

From here on, for purposes of simplicity, higher layer data-plane processing is depicted as if it is being performed at the eNB. All the embodiments apply equally to the mGW node. The mmW radio access technology may also be replaced by either 802.11ad or any other 802.11 based technology such as 802.11ac, 802.11n, or Wigig based technology and the like.

Based on flow-control messaging between the mGW/eNB and the mB(s) involved, the eNB can determine whether the QoS requirements for this particular data flow are met based on the current data split between the LTE channels and the mmW channels. For instance, this may be achieved by information exchanged from the mB(s) to the eNB based on configurable threshold limits, (where the thresholds indicate that data can be split between LTE and mmW channels). If the aggregated bit-rate requirements are not met, the eNB can react quickly and arrange for the data to be transmitted over the LTE channels.

From the perspective of mobility impact, this approach of RLC PDU data split enables minimal data loss during handovers for the mmW underlay layer. This is achieved due to the fact that RLC layer at the eNB or mGW is where ARQ is implemented and data is typically buffered. This also reduces the need for buffering at the mB due to ARQ handling. As the WTRU moves from source mB to the target mB while still being connected to the same eNB or mGW, RLC context is not lost as there is no need for RLC re-establishment. Any data that is not currently acknowledged at the RLC-level or buffered for retransmissions at ARQ level need not be discarded. Note that based on how frequently RLC status PDUs are exchanged and their triggering mechanisms, there is potential for a high number of RLC PDUs awaiting acknowledgement.

This approach also avoids the need for data forwarding between mBs during handover and still achieves lossless handover as long as the mBs are connected to the same mGW node. If the WTRU moves from one mGW to another mGW node during handover, data has to be forwarded at the PDCP layer similar to how it is done in a baseline LTE system.

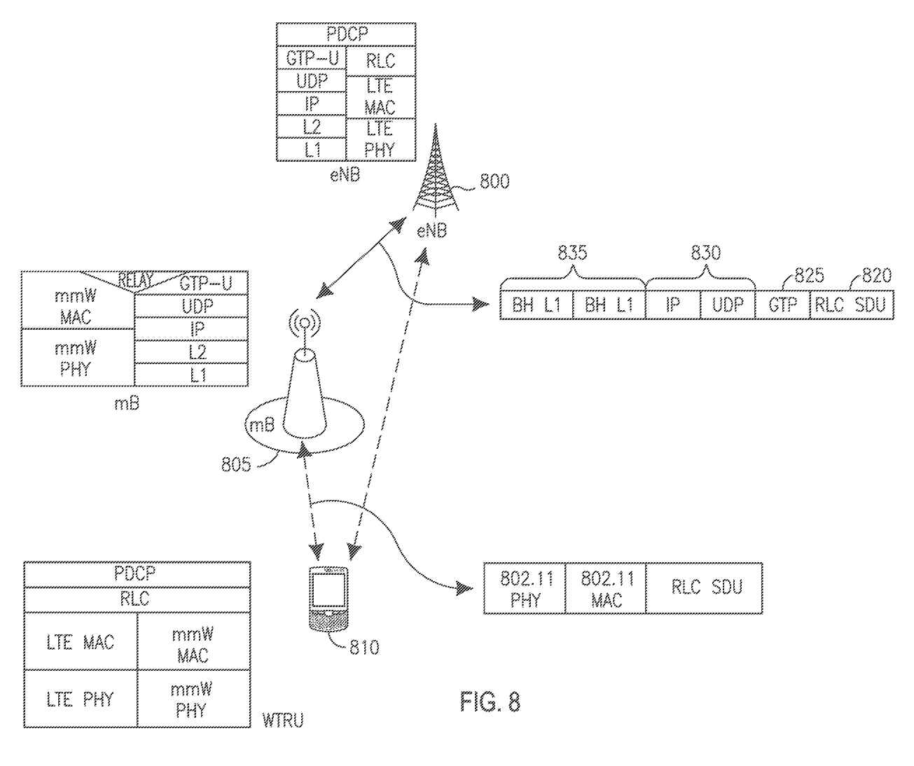

FIG. 8 shows an example of data-splitting using a RLC service data unit (SDU) approach. An eNB 800 is in communication with an mB 805 and a WTRU 810. In this approach, the PDCP entities terminate in the eNB 800 and the WTRU 810. Although an eNB is used in this description, it is applicable to the mGW. The mB executes mmW physical layer, mmW MAC layer and RLC layer functionality. It also provides support for backhaul links. The backhaul link could be based on mmW technology or any other technology such as a microwave link, any wired or fiber link, metro Ethernet or gigabit Ethernet link and the like. In this example, the RLC service data units (SDUs) 820 are embedded into general packet radio service (GPRS) tunneling protocol (GTP) 825 which runs over user datagram protocol/Internet Protocol (UDP/IP) 830 over the backhaul link 840 between the eNB 800 and the mB 805. The RLC SDUs 820 are transmitted between the mB 805 and WTRU 810, and the eNB 800 and the WTRU 810 over user-plane connections, i.e. the 802.11ad MAC and PHY, and the LTE MAC and PHY, respectively.

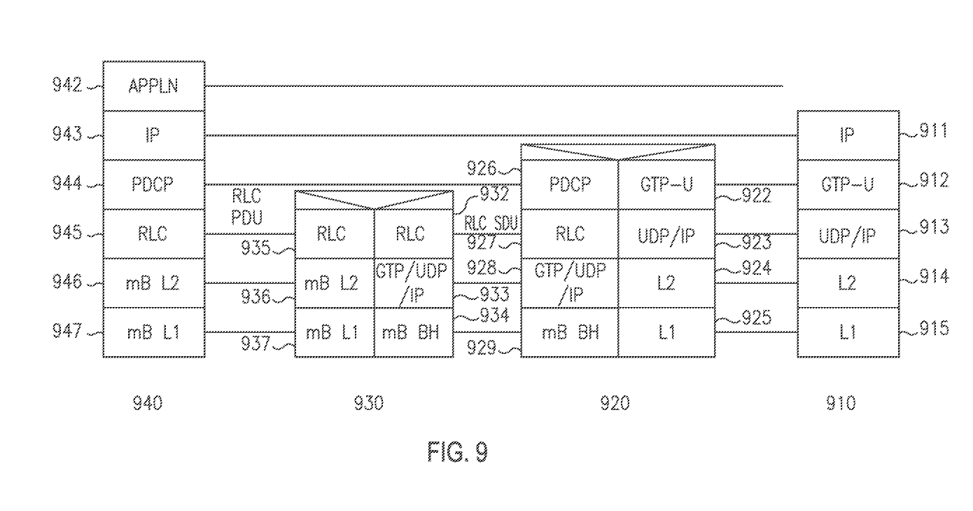

FIG. 9 shows an example view of a RLC SDU data splitting protocol stack 900. The RLC SDU data splitting protocol stack 900 includes a P-GW stack 910, an eNB stack 920, an mB stack 930 and a WTRU stack 940. The P-GW stack 910 includes an IP layer 911, a GTP-U layer 912, an UDP/IP layer 913, a L2 layer 914 and a L1 layer 915. The eNB stack 920 is a double column stack that includes on the P-GW side, a GTP-U layer 922, an UDP/IP layer 923, a L2 layer 924 and a L1 layer 925, and on the eNB side, a PDCP layer 926, a RLC layer 927, a GTP/UDP/IP layer 928 and a mB BH layer 929. The mB stack 930 is a double column stack that includes on the eNB side, a RLC layer 932, an UDP/IP layer 933, and a mB BH layer 934 and on the WTRU side, a RLC layer 935, a mB L2 layer 936, and a mB L1 layer 937. The WTRU stack 940 includes an application layer 942, an IP layer 943, a PDCP layer 944, a RLC layer 945, a mB L2 layer 946 and a mB L1 layer 947.

In this RLC SDU approach, the data-split may be performed across DRBs based on operator and user-policies and QoS/quality of experience (QoE) requirements of the data radio bearer (DRB) or the logical channel. This may simplify the data-splitting issue. This could be achieved using the RRC configuration. If a particular flow (DRB) were to be mapped from the LTE channels, (meaning sub 6 GHz cellular frequency channels), to mmW channels serviced by the eNB, this could be achieved by using RRC signaling, (for example, using RRC Reconfiguration messages). A similar approach may be taken if a particular flow (DRB) were to be mapped from the mmW channels to the LTE channels. This RLC SDU approach with data-split across DRBs or flows might require support for transfer of RLC SDU acknowledgements over the backhaul interface.

Alternatively, the data-split may also be performed within the same DRB or flow, meaning that the same DRB may be mapped to both LTE channels and mmW channels. There is a possibility that this could lead to out-of-sequence reception at the higher layers, (such as transmission control protocol (TCP)), since RLC is now terminated separately at the mB for mmW channel, at the eNB for LTE channels and at the mB for mmW channels. Leaky-bucket or rate-matching like algorithms may be used to reduce the reordering required at the TCP level by using some level of deep packet inspection at the eNB but this will not completely guarantee that there will be no out-of-sequence packets received at the TCP layer.

In the RLC-SDU approach, as the RLC entities terminate at the mB for the mmW layer, when a user moves from a source mB to a target mB, there is potential for data loss. If relevant procedures are not put in place, this sort of handoff from source mB to target mB even though the user might be attached to the same eNB will still lead to data loss.

If local-forwarding of data is preferred, then the eNB may not be required to buffer the data until it receives acknowledgements for PDCP PDUs that are transmitted. The eNB may transmit the PDCP PDUs and may depend on the RLC layer to transmit the data accordingly without data loss. At the time of handover, the RLC entities that are terminated at the mB for mmW channels will be re-established. This means, the RLC context at the mB(s) during handover will be lost. At the time of handover from the source mB to the target mB, (both being associated with the same eNB), any RLC SDUs, (i.e., PDCP PDUs), that are not transmitted yet to the WTRU may be forwarded from the source mB to the target mB. This is called local-forwarding between the mBs. This will ensure that any PDCP PDUs that are not yet transmitted will still be received at the WTRU, as they will transmitted from the target mB. Any RLC PDUs that need retransmission may still be lost.

Alternatively, the entire data-plane stack including the PDCP, RLC, mmW MAC and mmW PHY may be performed at the mB. This may require that ciphering be performed at the mB and may require ciphering engines and trust-zone features to be implemented at the mB. The data-loss at handover time from mB to another mB may be avoided by utilizing schemes that utilize PDCP status PDUs.

In an alternative embodiment, if local-forwarding of data is not used, then the data may be buffered at both the eNB and the mB. When the WTRU moves from the source mB to the target mB during handover, (both being associated with the same eNB), then the RLC entities at the mB are re-established. No data is forwarded from one mB to another mB. The PDCP status PDUs may be exchanged between the eNB and the WTRU to determine which PDCP PDU should be transmitted from the eNB to the target mB after the handover to proceed with data transfer. This will eliminate data loss but will require data buffering both at the eNB and the mB(s), (but may need to support exchange of RLC SDU or PDCP PDU acknowledgements over the backhaul interface). Alternatively, a periodic exchange of PDCP PDUs between the WTRU and the eNB may be introduced so that PDCP data buffers may be released at the eNB. If the WTRU moves from one eNB to another eNB node during handover, data has to be forwarded at the PDCP layer similar to baseline LTE systems.

Described herein are deployment scenarios for the RNE architecture. The RNE architecture is flexible enough to allow a variety of deployment configurations, depending on the location of various functional entities. This allows the new system to be easily built upon existing cellular (e.g., LTE) deployments. Support for mmW deployment in downlink only mode is also envisioned.

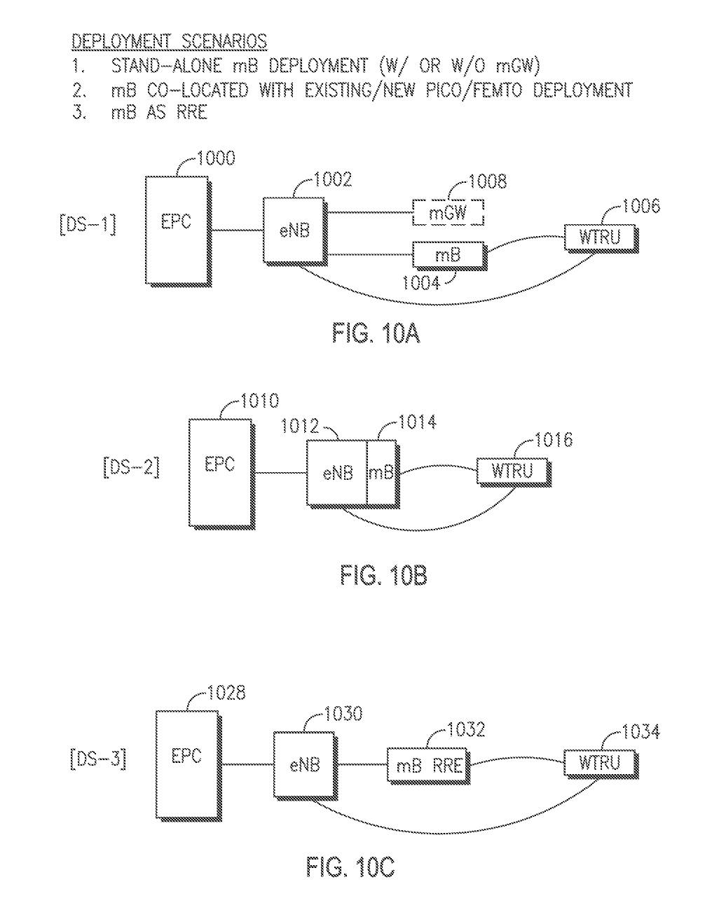

Four example deployment scenarios (DS) are described herein below. These include a standalone mB deployment (DS-1), an mB co-located with a Pico/Femto cell node/relay node (DS-2), and an mB acting as Remote Radio Equipment (RRE) (DS-3). FIGS. 10(a)-10(d) show top level views of each of the four deployment scenarios. In particular, the DS-1 scenario in FIG. 10(a) includes an evolved packet core (EPC) 1000, an eNB 1002, a standalone mB 1004 and a WTRU 1006. The DS-1 scenario may include an mGW 1008. The DS-2 scenario in FIG. 10(b) includes an EPC 1010, an eNB 1012, a co-located mB 1014 and a WTRU 1016. The DS-3 scenario includes an EPC 1028, an eNB 1030, an mB 1032 acting as RRE and a WTRU 1034.

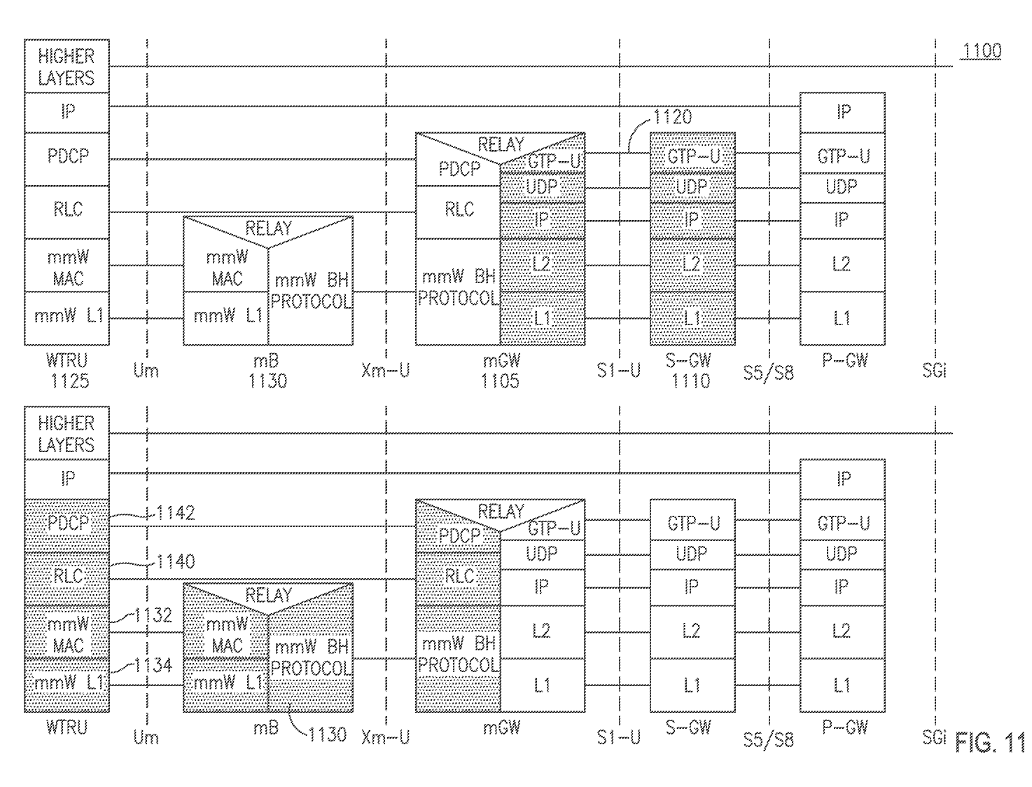

The RNE protocol architectures for the different sample deployment scenarios are shown in FIGS. 11-17. For the sake of simplicity, only the RLC PDU approach is shown for the protocol stack views below for these different deployment scenarios. The RLC-SDU approach protocol stack views are equally applicable. An architectural feature is that the mmW MAC sublayer is terminated at the mB, whereas the PDCP and RLC sub-layers are terminated at the mGW or the eNB, depending on whether the mGW is part of the architecture or not, respectively.

FIG. 11 shows an example user-plane protocol stack view 1100 for DS-1 with an mGW node. The user-plane protocol stack between an mGW 1105 and a serving gateway (S-GW) 1110 uses a GTP-U 1120 for the S1-U interface. The user-plane protocol stack between a WTRU 1125 and an mB 1130 uses an mmW MAC layer 1132 and mmW physical layer 1134. The RLC layer 1140 and PDCP layer 1142 reside in the WTRU 1125 and the mGW 1105. The mB 1130 and the mGW 1105 use the mmW backhaul (BH) protocol 1150 over the Xm-U interface.

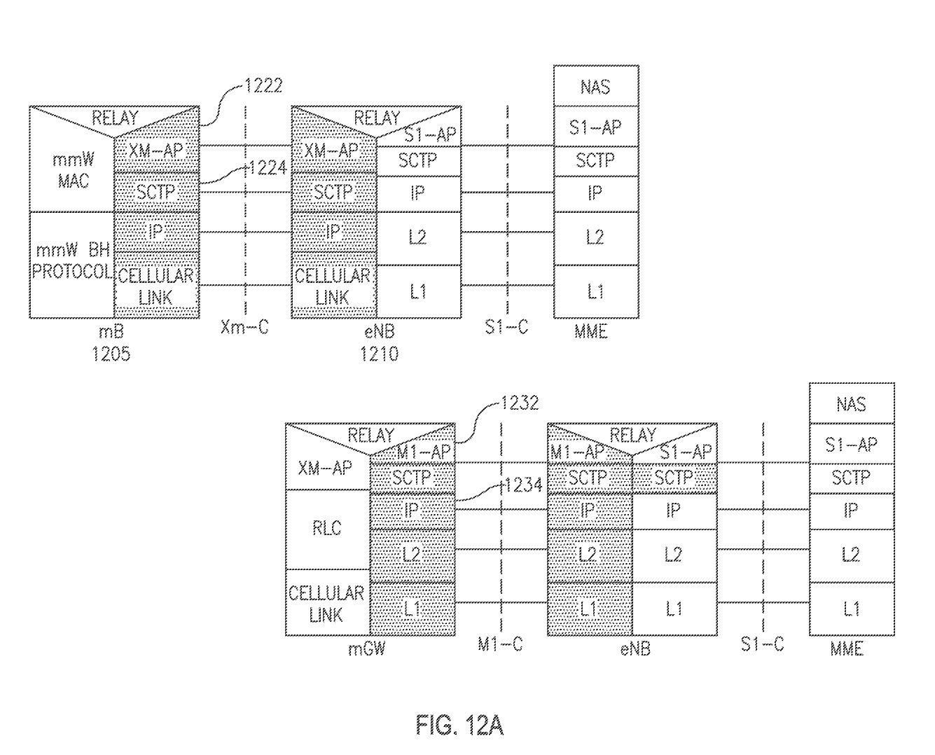

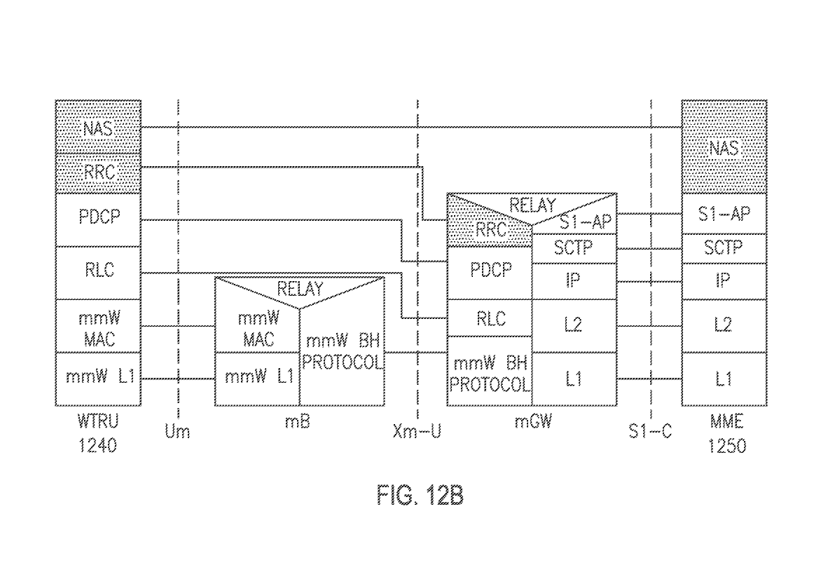

FIGS. 12A and 12B show an example control plane protocol stack view 1200 for DS-1 with an mGW node. The control-plane protocol stack between an mB 1205 and an eNB 1210 uses the mmW management application protocol (XM-AP) 1222 over Stream Control Transmission Protocol (SCTP)/IP 1224 that is carried on the low throughput cellular link for the Xm-C interface. The control-plane protocol stack between the an mGW 1230 and the eNB 1210 uses the mGW management application protocol (M1-AP) 1232 over the SCTP/IP 1234 that is carried on a wired link for the M1-C interface. The control protocol stack between a WTRU 1240 and the eNB 1210 and a MME 1250 remains the same as in a baseline LTE Release 10 network, i.e. RRC 1252 and NAS 1254, for example.

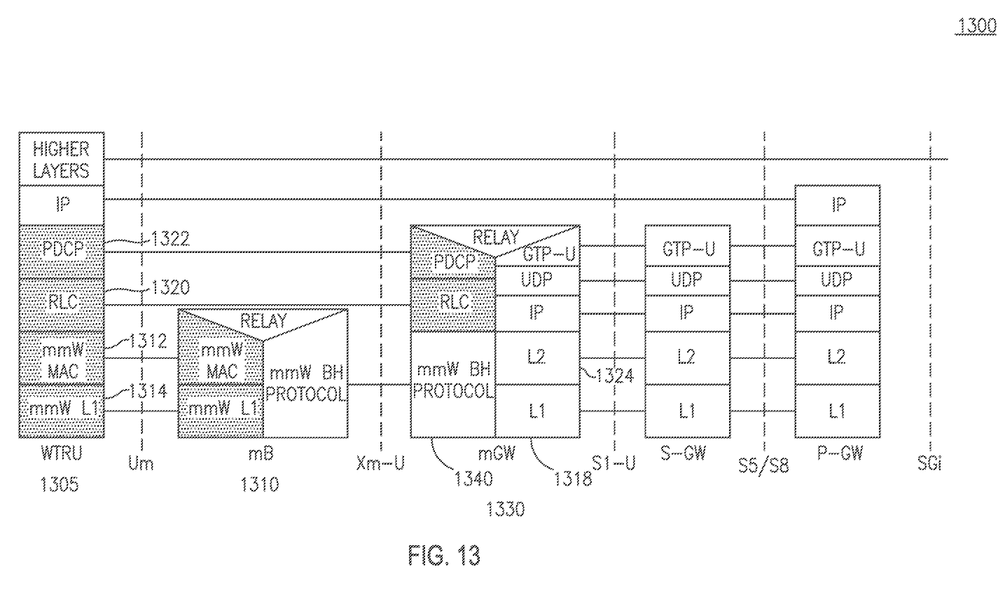

FIG. 13 shows an example user-plane protocol stack view 1300 for DS-1 without an mGW node. The user-plane protocol stack between a WTRU 1305 and an mB 1310 uses an mmW MAC layer 1312 and an mmW physical layer 1314. A RLC layer 1320 and a PDCP layer 1322 reside in the WTRU 1305 and an eNB 1330, respectively. The mB 1310 and the eNB 1330 use the mmW backhaul (BH) protocol 1340 over the Xm-U interface.

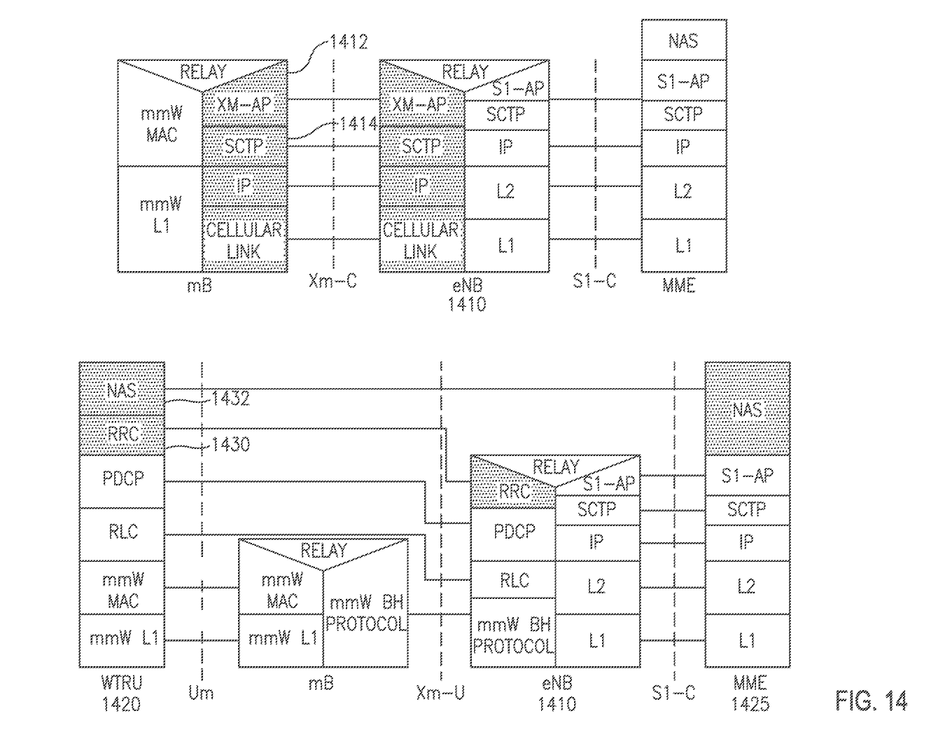

FIG. 14 shows an example control plane protocol stack view 1400 for DS-1 without an mGW node. The control-plane protocol stack between an mB 1405 and an eNB 1410 uses an mmW management application protocol (XM-AP) 1412 over SCTP/IP 1414 that is carried on the low throughput cellular link for the Xm-C interface. The control protocol stack between a WTRU 1420 and the eNB 1410 and an MME 1425 remains the same as in a baseline LTE Release 10 network, i.e. RRC 1430 and NAS 1432, for example.

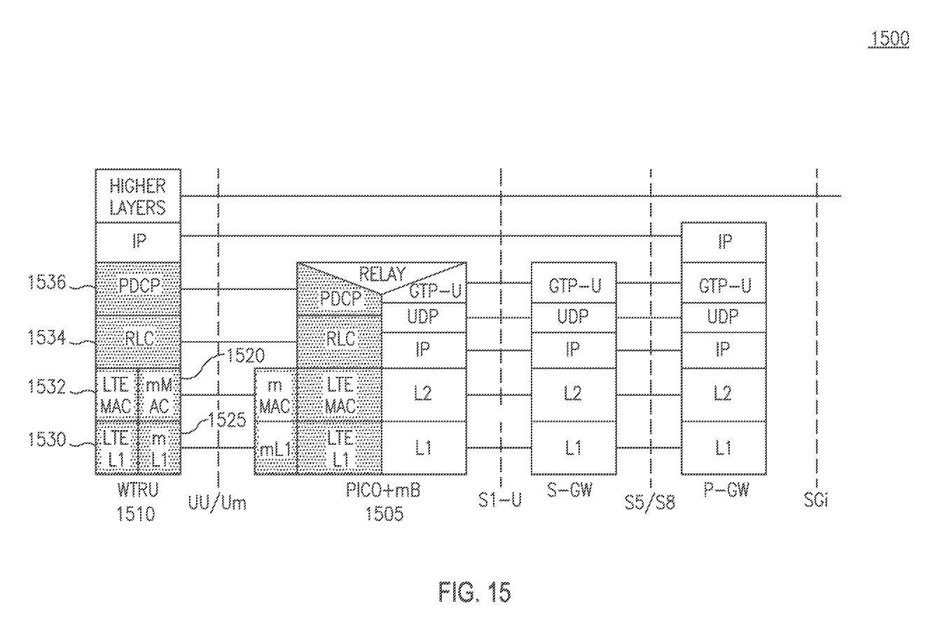

FIG. 15 shows an example user-plane protocol stack view 1500 for DS-2 that shows an mB co-located with an existing Pico/Femto/Relay cell node (mB/Pico) 1505. The user-plane protocol stack between a WTRU 1510 and an mB side of mB/Pico 1505 uses an mmW MAC layer 1520 and an mmW physical layer 1525. A LTE based physical layer 1530, MAC layer 1532, RLC layer 1534 and PDCP layer 1536 reside in the WTRU 1510 and an eNB, i.e. Pico cell, side of mB/Pico 1515, respectively.

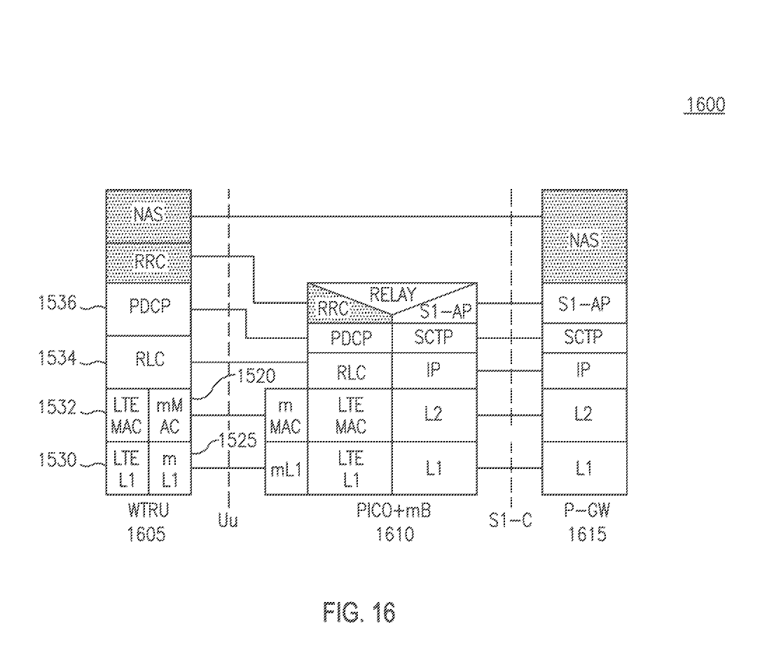

FIG. 16 shows an example control-plane protocol stack view 1600 for DS-2. The control protocol stack between a WTRU 1605, eNB of mB/Pico 1610 and an MME 1615 remains the same as in a baseline LTE Release 10 network.

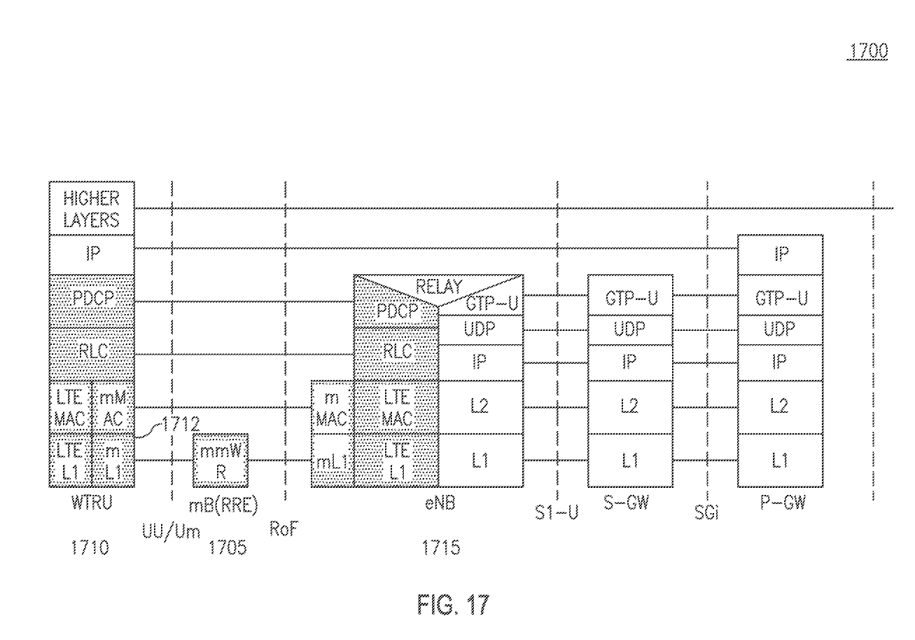

FIG. 17 shows an example user-plane protocol stack view 1700 for DS-4 that shows an mB as a remote radio entity (RRE) 1705. The user-plane protocol stack between a WTRU 1710 and the mB 1705, and between the mB 1705 and an eNB 1715 uses an mmW L1 layer 1712 and 1714, respectively.

Described herein is a small-cell cloud RAN. Small-cell cloud RAN (SCC-RAN) architecture is advantageous if mBs are deployed in an ultra-dense fashion, (for example in public spaces such as stadiums, malls, school campuses and the like). The SCC-RAN also has the ability of supporting mmW and other high throughput technologies that are developed outside cellular systems such as 802.11ad, Wireless HD, 802.15.3c or other flavors of the 802.11 family such as 802.11ac or 802.11n. It integrates these disparate technologies into a cellular system in a seamless fashion. It brings cellular system advantages such as AAA functions, security and advanced mobility techniques with minimal data loss. It also provides a cellular operator the ability to provide garden-walled cellular services that are specific to the operator over these high throughput technologies and integrates these technologies to be part of the cellular fabric.

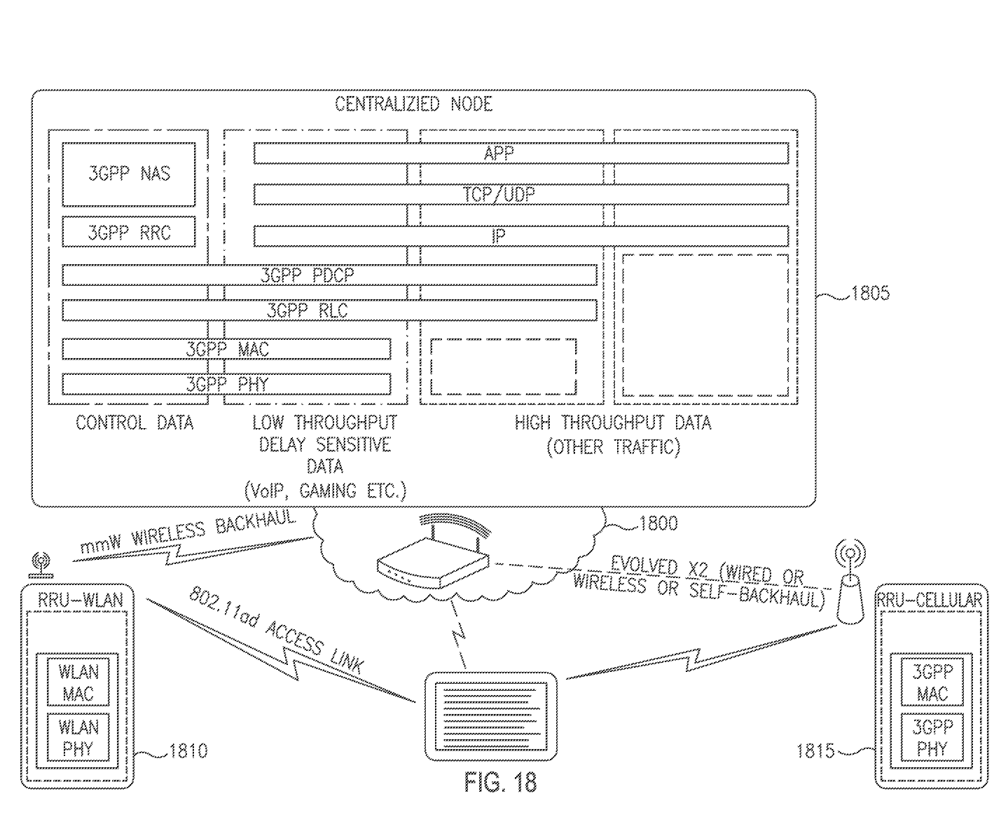

FIG. 18 shows an example SCC-RAN architecture 1800. The SCC-RAN architecture 1800 is a cloud architecture driven by centralized RAN node(s) 1805, which are augmented with many Remote Radio Units (RRU) 1810 and 1815, for example, to provide extreme capacity and coverage. It also includes centralized control plane and distributed data plane functions, (i.e. lower MAC/PHY) and the RAN node terminates control plane and higher data plane layers, (for example PDCP and RLC). The RRUs may be 802.11xx APs (incl. 802.11ad) or cellular units with PHY and MAC functionality.

The SCC-RAN architecture reduces the need for connecting each RRU node directly to the centralized node by using, for example, a mesh backhaul. The mesh backhaul can leverage the combination of wired and wireless links. This mechanism provides a way to utilize existing wired infrastructure such as power-line communication (PLC), Ethernet or fiber based technologies. This also enables utilization of existing mmW technologies such as 802.11ad, wireless HD or 802.15.3c to be used as backhaul or access technology.

The SCC-RAN architecture also enables backhaul links to be established dynamically or as required to different neighboring nodes based on traffic, load-balancing or other requirements. Backhaul routing may be based on link metrics defined for each backhaul link.

This architecture also reduces the stringent latency requirements on the backhaul as TTI based scheduling is performed at the RRU or edge node. This also ensures that the edge nodes are not tied to a single radio access technology (RAT). This will enable cheaper edge nodes (RRUs). This SCC-RAN architecture also minimizes data loss due to mobility as the RLC layer is still terminated at the edge nodes. Window based and buffering mechanisms are implemented in the RLC layer. Any retransmissions are also handled by the RLC layer. The SCC-RAN architecture also enables thin edge nodes. Control-plane and higher layer data plane, (including ciphering/integrity algorithms), run at the centralized RAN node. Security and ciphering/integrity algorithms are executed at the centralized RAN node and the edge need not have any trust zone features.

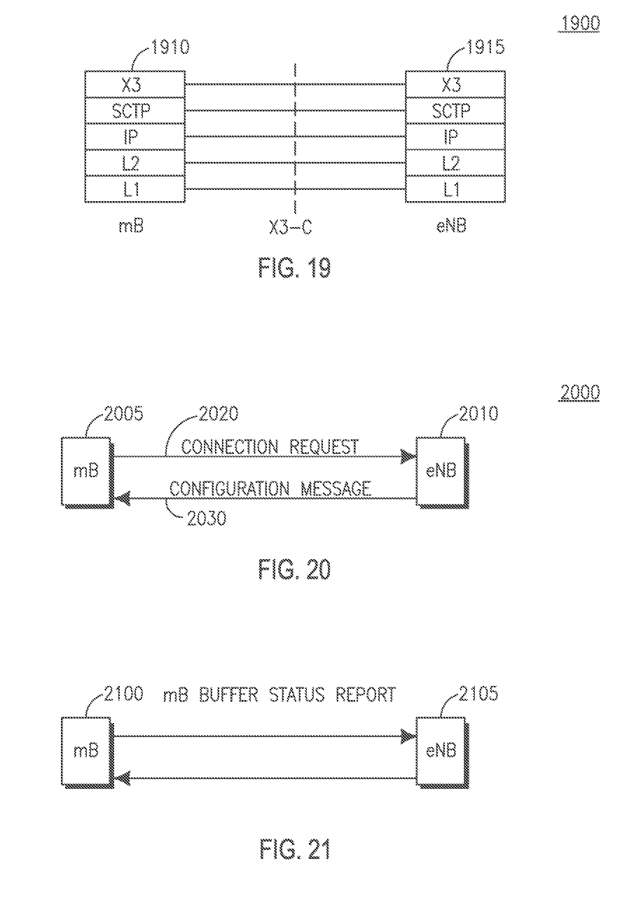

FIG. 19 shows an example X3-C protocol view 1900. The X3-C interface 1905 is for control plane messaging between an mB 1910 and an eNB 1915. The messaging may be carried upon SCTP over IP over L2 over L1, as shown. The X3-C messaging may perform the following functions to enable operation and management of the mB 1910: mB initiation, mB handover, mB flow control, and buffer status reporting

FIG. 20 shows an example message sequence 2000 between an mB 2005 and an eNB 2010 for mB initiation. The mB initiation message is triggered when a new mB 2005 tries to establish a connection with the eNB 2010. Depending on the mB capabilities, the mB initiation procedure may be performed as a RRC connection establishment procedure or a new procedure using a protocol. The parameters sent by the mB 2005 in the connection request message 2020 may include mB node capabilities, i.e. capability to support self-backhaul or full-duplex access and backhaul links, capability of backhaul RAT that can be supported, buffer/memory size available for downlink and uplink HARQ processes, scheduler configuration, and the like.

The parameters sent in the mB configuration message 2030 may include resource configuration for access and backhaul links, i.e. sub-frame configuration, resource configuration, frequency of operation, component carrier configuration, bandwidth of operation, and the like. It may also include measurement configuration for measurements that need to be performed at the mB node. For example, this ma be resources on which the mB node should perform intra-frequency and inter-frequency measurements, periodicity of measurements, white list and black list cell list, and per carrier (or frequency) configuration for e.g. gap configuration. The mB configuration message 2030 may also include reporting configuration for measurements, where the configuration could include triggers for reporting measurements, periodicity of measurement reports and the like. Other information may include: 1) buffer status reporting configuration, where the report details existing buffers available in downlink and uplink direction; 2) scheduler status message, which may have scheduler specific information of the flows; or 3) an access channel status message which may include channel utilization statistics, channel load observed and the like.

FIG. 21 shows an example message sequence for mB flow control between an mB 2100 and an eNB 2105. The mB 2010 node may send an indication to the eNB 2105 to indicate the status of the buffer occupancy of the mB buffers. The mB 2010 may maintain separate buffers for downlink and uplink transmissions.

The mB buffer status report may be triggered in the following conditions: 1) when the mB node establishes/re-establishes connection with the eNB; 2) when the mB node buffer availability changes by more than a delta threshold; 3) when the amount of free buffer available at the mB node is less than or equal to a configured minimum threshold; 4) periodically as configured by the eNB; 5) when a WTRU operating with the mB node is being handed out of mB node operation, i.e. either to another mB node or to the eNB; and 5) when congestion condition is detected or relieved.

The mB buffer status report may be organized by overall buffer status, buffer status per logical channels, buffer status per radio bearers or buffer status per logical channel group.

Additional messages the mB 2105 may send to the eNB 2110 for flow control include: 1) congestion start notification—this could be triggered when the mB detects congestion in the access link or back up in the buffered content; 2) congestion stop notification—when congestion is relieved; 3) ready notification—when the mB is ready to start receiving packets for a WTRU; and 4) stop notification—when a mB needs to stop getting packets for a WTRU.

Described herein is messaging for outbound handovers, i.e. when the WTRU moves out of the mB node. Messages to support outbound handover may include: 1) a notification when the WTRU radio link condition falls below a minimum threshold; 2) a notification if a WTRU or list of WTRUs need to be handed out because the mB node is congested/overloaded, or if the mB node needs to be turned off (for energy savings); sequence numbers of last acknowledged frame; sequence number of last unacknowledged frame; and WTRU statistics, including last set of channel quality measurements for target cell received by the WTRU node, including channel quality indicator (CQI), received signal Reference Signal Received Power (RSRP) measurements and the like.

Additional messaging that may support mB-mB handover in case local forwarding is supported may include RLC PDU status PDU, PDCP status PDU and security configuration for the WTRU that is being handed over.

Described herein is messaging for inbound handover. To trigger an inbound handover, the mB node may send a notification to the eNB when a new WTRU is detected. For the WTRU being handed to an mB node, the eNB may send the following configuration messages to the mB node: 1) WTRU context being handed to mB node; and 2) security challenge text and response when a WTRU is being handed over.

Described herein is messaging to support mB termination. For energy savings or other reasons, the eNB may send a power off notification to the mB node. The mB node may respond with a list of WTRUs that it is currently configured to support, and need to be handed over. In another option, the mB node periodically reports the list of WTRUs being supported and their current status, i.e. radio conditions, buffer status, last acknowledged SN, and the like. The eNB may then send a notification to the WTRUs to remove configuration or disassociate these WTRUs either by sending a message directly to the WTRUs or notifying the mB node.

Described herein is messaging to support QoS configuration. When a new WTRU is handed to the mB node, (either mB->eNB or mB->mB handover), the mB may be configured with the incoming WTRU's context. The WTRU context may include: 1) a set of logical channels to be supported for the WTRU, along with the QoS parameters, (for example, MBR values, latency that needs to be supported and the like); and 2) the mB may accept or reject the configuration depending on the mB admission control using handover accept or handover reject message.

The X3 interface could be a new interface or implemented as self-backhaul using time division multiplexing (TDM) resources between access and backhaul. In the TDM alternative, the X3 resources may be configured by the eNB during initiation, so that X3 interface is available only on configured sub-frames or resources.

Described herein are mobility scenarios. Handover in the RNE framework is a WTRU-assisted, cellular network-controlled procedure. Handover decision may be based on WTRU measurement reports that could include received power estimates of reference signals or beacons from neighboring mBs. Description for the mB-mB, mB-eNB and eNB-mB handover procedures are presented below. Even though these handover procedures are described with the eNB, they are extendable and applicable to the mGW based architecture described herein above.

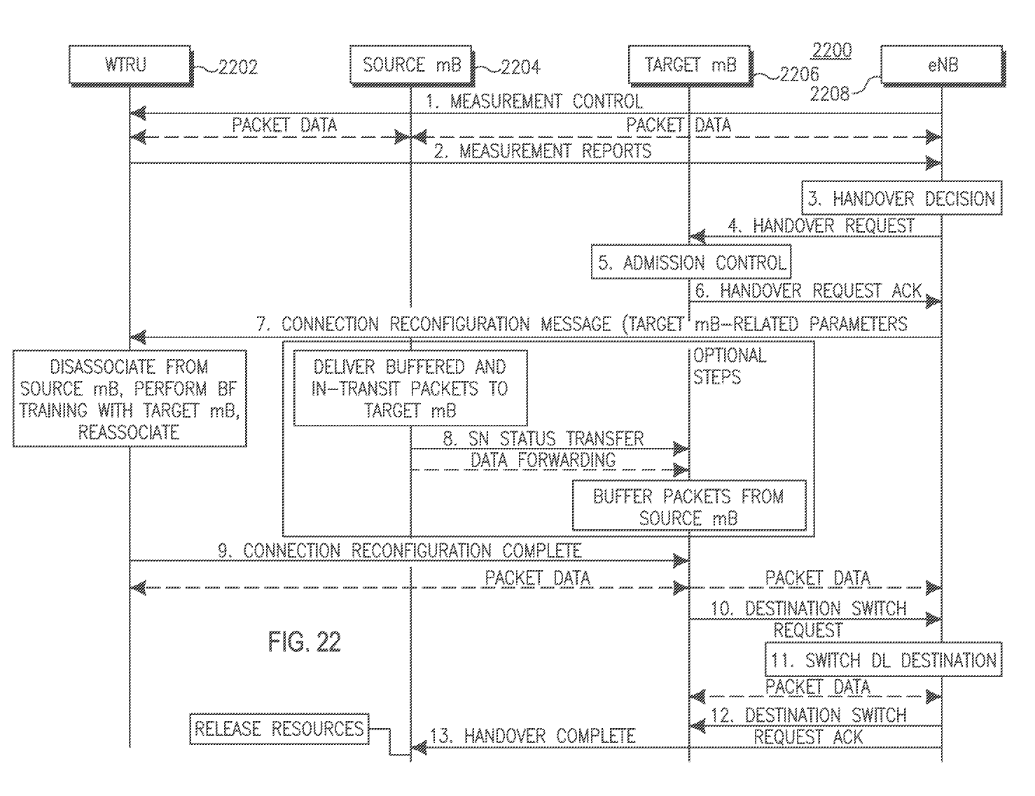

FIG. 22 shows an example message sequence chart 2200 for mB-mB mobility between a WTRU 2202, source mB 2204, target mB 2206 and eNB 2208. The handover procedure is performed without EPC involvement. The release of the resources at the source side during handover is triggered by the eNB 2208.

The eNB 2208 configures WTRU 2202 measurement procedures according to area restriction information which was provided either at connection establishment or at the last TA update (1). The eNB 2208 may provide the WTRU 2202 with a list of possible neighboring mBs and their corresponding reference signal parameters or beacon transmission instants to aid measurements. The WTRU is triggered to send Measurement Reports by already established reporting configuration (2). The eNB 2208 makes a decision based on Measurement Reports and RRM information to hand off the WTRU 2202 (3). This may be influenced by the load at the current mB and also based on the load over the backhaul links in addition to the mmW access link channel quality from the source mB 2204.

The eNB 2208 issues a Handover Request message to the target mB 2206, passing necessary information to prepare the handover at the target side (4). Admission control may be performed by the target mB 2206 dependent on the received QoS information to increase the likelihood of a successful handover, if the resources can be granted by the target mB 2206 (5). The target mB 2206 prepares handover with L1/L2 and sends the Handover Request Acknowledge to the eNB 2208 (6). This message may also include radio network layer/transport network layer (RNL/TNL) information for the forwarding tunnels, if necessary.

The eNB 2202 generates the Connection Reconfiguration message including target mB-related parameters and sends it to the WTRU (7). This triggers the WTRU to perform the handover. The WTRU does not need to delay the handover execution for delivering the hybrid automatic repeat request/automatic repeat request (HARQ/ARQ) responses to the eNB 2208.

The source mB 2204 may send the SN Status Transfer message to the target mB 2206 to convey the uplink PDCP SN receiver status and the downlink PDCP SN transmitter status of evolved-radio access bearers (E-RABs) (data radio bearers) for which PDCP status preservation applies, (i.e., for RLC acknowledge mode (AM)) (8). The source mB 2204 may omit sending this message if none of the E-RABS of the WTRU 2202 shall be treated with PDCP status preservation. This may be influenced by whether RLC-PDU or RLC-SDU data split approaches are used.

When the WTRU 2202 has successfully associated with the target mB 2206, it sends a Connection Reconfiguration Complete message to confirm the handover, along with an uplink Buffer Status Report, whenever possible, to the target mB (9). The target mB 2206 may now begin sending data to the WTRU 2202.

The target mB 2206 sends a Destination Switch Request message to the eNB 2208 to inform that the WTRU has changed mBs (10). This message may be a Handover Response message which conveys similar information to the eNB 2208. The eNB 2208 switches the downlink data path to the target side (11). The eNB 2208 confirms the Destination Switch Request message with the Destination Switch Request Acknowledge message (12). Upon receiving the Handover Complete message, the source mB 2204 can release radio resources associated to the WTRU context (13). Any ongoing data forwarding may continue.

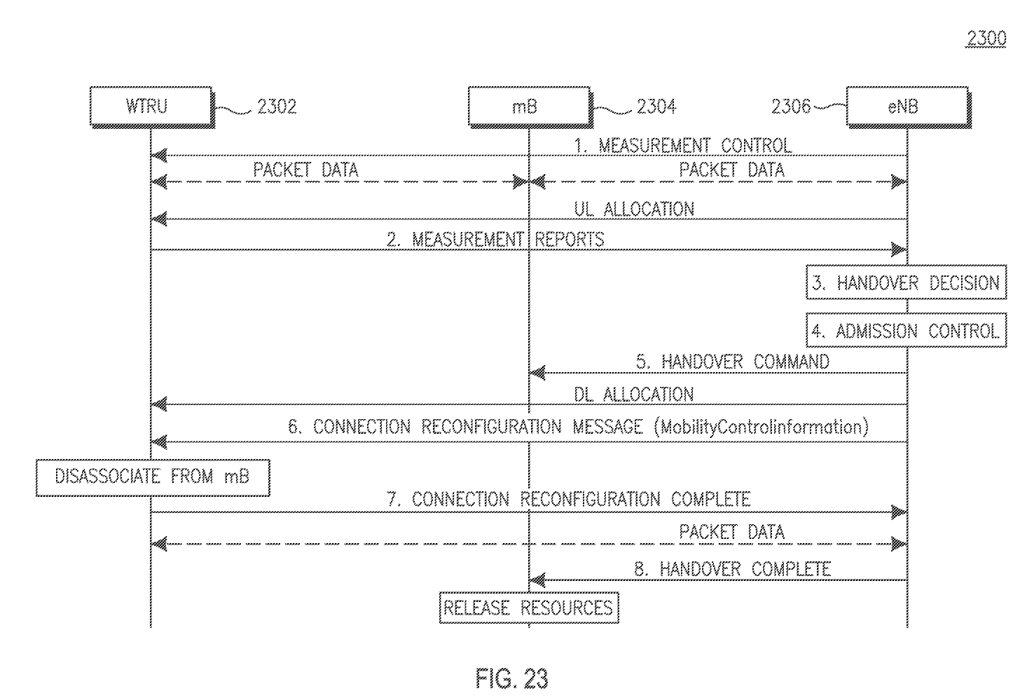

FIG. 23 shows an example message sequence chart 2300 for mB-eNB mobility between a WTRU 2302, mB 2304 and eNB 2306. The eNB 2306 configures WTRU measurement procedures according to area restriction information which was provided either at connection establishment or at the last tracking area (TA) update (1). The eNB 2306 may provide the WTRU 2302 with a list of possible neighboring mBs and their corresponding reference signal parameters or beacon transmission instants to aid measurements. The WTRU 2302 is triggered to send Measurement Reports by already established reporting configuration (baseline LTE Release 10) (2).

The eNB 2306 makes a decision based on Measurement Reports and RRM information to hand off the WTRU 2302 to itself (3). This may be due to reasons such as, but not limited to, excessive loading at mB and lack of suitable neighboring mB, or link quality to mB deteriorating below a particular threshold and lack of suitable neighboring mBs based on received Measurement Reports. Admission control may be performed by the eNB 2306 dependent on the received QoS information to increase the likelihood of a successful handover (4).

The eNB 2306 issues a Handover Command to the mB 2304 to stop downlink packet transmissions to WTRU 2302 (5). The eNB 2306 generates the Connection Reconfiguration message including mobilityControlinformation and sends it to the WTRU 2302 (6). This triggers the WTRU 2302 to disassociate from mB 2304. The WTRU 2302 does not need to delay the handover execution for delivering the HARQ/ARQ responses to the eNB 2306. After disassociating from mB 2304, the WTRU 2302 sends a Connection Reconfiguration Complete message to confirm the handover, along with an uplink Buffer Status Report, whenever possible, to the eNB 2306 (7). The eNB 2306 can now begin sending data to the WTRU 2302. Upon receiving the Handover Complete message, the mB 2304 can release radio resources and data buffers associated to the UE context (8).

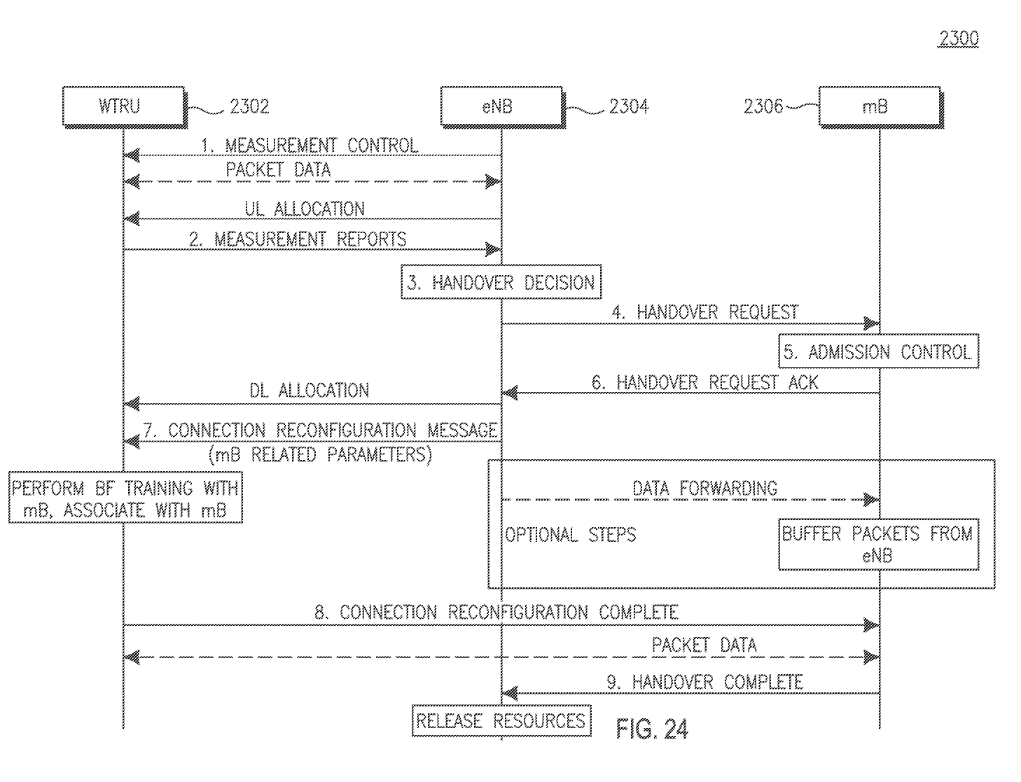

FIG. 24 shows an example message sequence chart 2400 for eNB-mB mobility between a WTRU 2402, mB 2404 and eNB 2406. The eNB 2404 configures UE measurement procedures according to area restriction information which was provided either at connection establishment or at the last TA update (1). The eNB 2404 may provide the WTRU 2402 with a list of possible neighboring mBs and their corresponding reference signal parameters or beacon transmission instants to aid measurements. The WTRU 2402 is triggered to send Measurement Reports by already established reporting configuration (2). The eNB 2404 makes a decision based on Measurement Reports and RRM information to hand off the WTRU 2402 to mB 2406 (3). This may be due to reasons such as, but not limited to, excessive loading at eNB, or particular QoS requirements of certain data flows.

The eNB 24004 issues a Handover Request message to the mB 2406, passing necessary information to prepare the handover at the target side (4). Admission control may be performed by the mB 2406 dependent on the received QoS information to increase the likelihood of a successful handover (5). The target mB 2406 prepares handover with L1/L2 and sends the Handover Request Acknowledge to the eNB 2404 (6). This message may also include RNL/TNL information for the forwarding tunnels, if necessary.

The eNB 2404 generates the Connection Reconfiguration message including mB-related parameters and sends it to the WTRU 2402 (7). This triggers the WTRU 2402 to perform the handover. The WTRU 2402 does not need to delay the handover execution for delivering the HARQ/ARQ responses to the eNB 2404. When the WTRU 2402 has successfully associated with the mB 2406, it sends a Connection Reconfiguration Complete message to confirm the handover, along with an uplink Buffer Status Report, whenever possible, to the mB 2406 (8). The mB 2406 may now begin sending data to the WTRU 2402. Upon receiving the Handover Complete message, the eNB 2404 can release radio resources associated to the UE context (9). Any ongoing data forwarding may continue.

Described herein is simultaneous reception from multiple mBs. The ability to maintain simultaneous communication links with multiple base stations increases WTRU throughput, and also possibly reduces handover duration and enhances user quality of experience (QoE). Usually a WTRU allocates separate time or frequency resources for communicating with multiple base stations, corresponding to time-division multiplexing (TDM) and frequency-division multiplexing (FDM) modes, respectively. While separate radio frequency (RF) chains may not be necessary for these operations, modularity and cheaper individual components result from multiple chains. However, multiple RF chains for TDM mode allow each oscillator to be synchronized to individual base stations, and also allow faster switching. Moreover, in case of large signal bandwidth, a common RF chain may not be technically or economically viable for FDM operations.

At millimeter wave frequencies, in addition to FDM and TDM modes for simultaneous downlink reception, spatial multiplexing is also possible due to highly directional transmissions. A WTRU with multiple antennas may simultaneously generate separate, independent beams from each of them. Alternatively, an antenna array may produce multiple simultaneous beamformed links to separate mBs. The TDM, FDM and spatial division multiplexing (SDM) mode operations are described herein below.

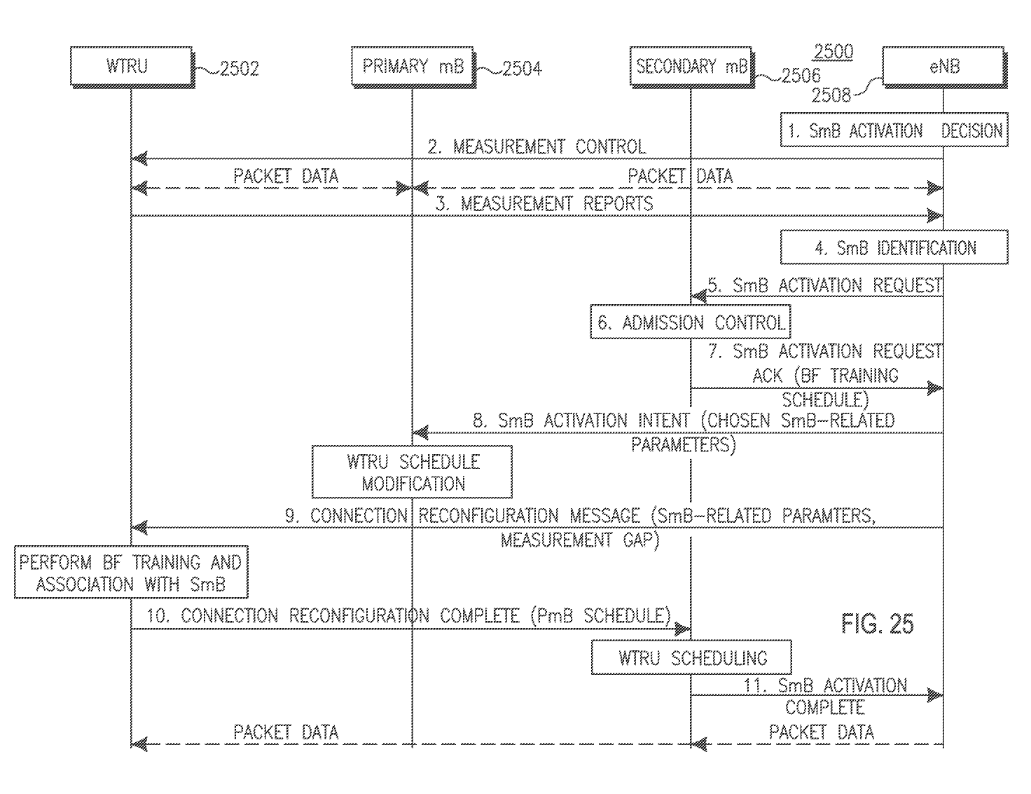

FIG. 25 shows an example message sequence chart for TDM mode of simultaneous downlink transmission between a WTRU 2502, primary mB 2504, secondary mB 2506 and an eNB 2208. The eNB 2508 exercises overall control over simultaneous TDM operations, and activates secondary mB 2506 for downlink transmission to WTRU 2502. Following link set-up between mB and WTRU 2502, the eNB 2508 decides to activate an additional downlink channel to WTRU 2502 through another mB (1). The original mB is henceforth caller primary mB 2504 and the additional mB is referred as secondary mB 2506. The decision may be based on several factors such as load balancing considerations, QoS requirements or as back-up in case of primary link failure.

The eNB 2508 configures UE measurement procedures according to area restriction information which was provided either at connection establishment or at the last TA update (2). The eNB 258 may provide the WTRU 2502 with a list of possible neighboring mBs and their corresponding reference signal parameters or beacon transmission instants to aid measurements. The WTRU 2502 is triggered to send Measurement Reports by an already established reporting configuration (3).

The eNB 2508 identifies potential Secondary mB based on Measurement Reports and RRM information (4). The eNB 2508 issues a SmB Activation Request message to the identified secondary mB 2506, passing necessary information to prepare secondary mB activation (5). Admission control may be performed by the secondary mB 2506 dependent on the received QoS information to increase the likelihood of a successful secondary mB 2506 activation (6).

The secondary mB 2506 sends the secondary mB Request Acknowledge to the eNB 2508 (7). This message may include proposed beamforming training schedule for WTRU 2502. The eNB 2508 generates the SmB Activation Intent message including Secondary mB-related parameters and sends it to the primary mB 2504 (8). This triggers the primary mB 2504 to move any scheduled transmissions to the WTRU 2502 at the proposed beamforming time by the secondary mB 2506. If it is not possible to reschedule WTRU 2502 transmissions, it indicates this to the eNB 2508, which then requests the secondary mB 2506 to propose a different beamforming training schedule.

The eNB 2508 notifies WTRU 2502 of secondary mB-related parameters and measurement gap for beamforming training with secondary mB via Connection Reconfiguration message (9). The WTRU 2502 sends Connection Reconfiguration Complete message to secondary mB 2506 after successfully completing beamforming training and associating with it. It also includes its time allocations with primary mB 2504 in the message (10). The secondary mB 2506 then chooses a different time allocation for the WTRU 2502. The secondary mB 2506 then sends a secondary mB Activation Complete message to the eNB 2508 to indicate successful activation of the downlink channel (11).

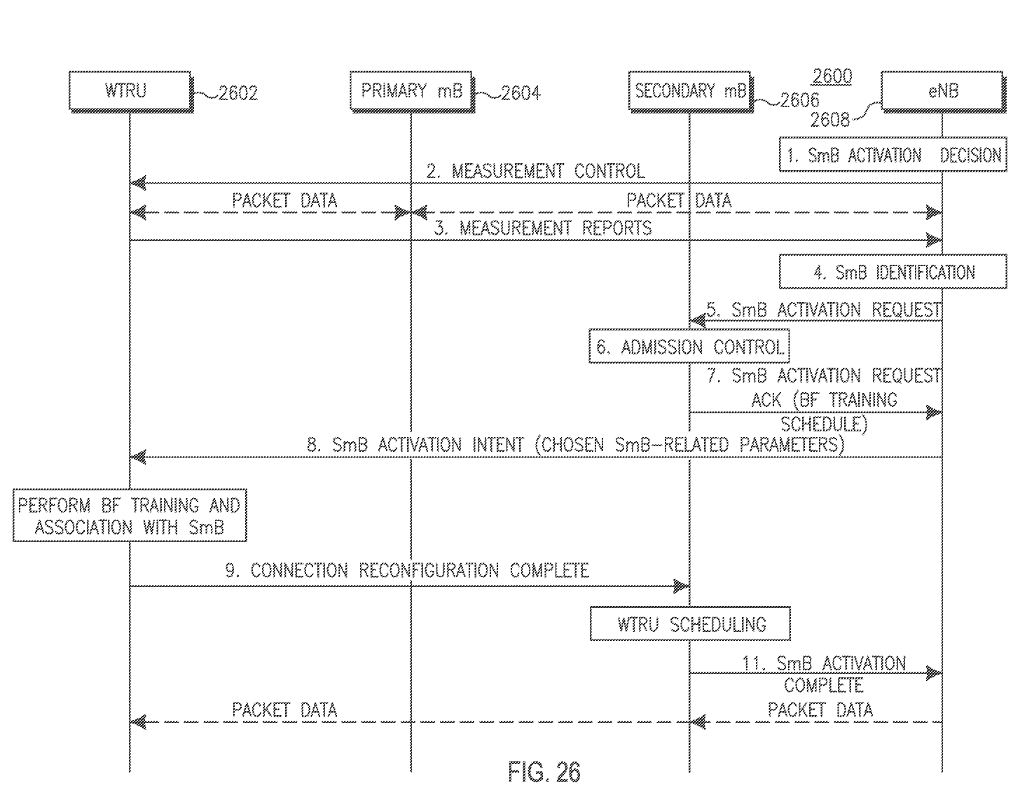

FIG. 26 shows the message sequence chart 2600 for FDM mode of simultaneous downlink transmission between a WTRU 2602, primary mB 2604, secondary mB 2606 and an eNB 2608. This is identical to the TDM mode, except that data transfer rescheduling on primary channel is not required for beamforming training with secondary mB 2606. Accordingly, the primary mB 2604 is not informed of the secondary link set-up by the eNB 2608.

The eNB 2608 exercises overall control over simultaneous TDM operations, and activates secondary mB 2606 for downlink transmission to WTRU 2602. Following link set-up between mB and WTRU 2602, the eNB 2608 decides to activate an additional downlink channel to WTRU 2602 through another mB (1). The original mB is henceforth referred to as the primary mB 2604 and the additional mB is referred as secondary mB 2606. The decision may be based on several factors such as load balancing considerations, QoS requirements or as back-up in case of primary link failure.

The eNB 2608 configures UE measurement procedures according to area restriction information which was provided either at connection establishment or at the last TA update (2). The eNB 2608 may provide the WTRU 2602 with a list of possible neighboring mBs and their corresponding reference signal parameters or beacon transmission instants to aid measurements. The WTRU 2602 is triggered to send Measurement Reports by an already established reporting configuration (3).

The eNB 2608 identifies potential secondary mB based on Measurement Reports and RRM information (4). The eNB 2608 issues an SmB Activation Request message to the identified secondary mB 2606, passing necessary information to prepare secondary mB activation (5). Admission control may be performed by the secondary mB 2606 dependent on the received QoS information to increase the likelihood of a successful secondary mB 2606 activation (6).

The secondary mB 2606 sends the secondary mB Request Acknowledge to the eNB 2608 (7). This message may include proposed beamforming training schedule for WTRU 2602. The eNB 2608 notifies WTRU 2602 of secondary mB-related parameters and measurement gap for beamforming training with secondary mB via Connection Reconfiguration message (8). The WTRU 2602 sends a Connection Reconfiguration Complete message to secondary mB 2604 after successfully completing beamforming training and associating with it. It also includes its time allocations with Primary mB 2604 in the message (9). The secondary mB 2606 then chooses a different time allocation for the WTRU 2502. The secondary mB 2606 then sends a secondary mB Activation Complete message to the eNB 2608 to indicate successful activation of the downlink channel (10).

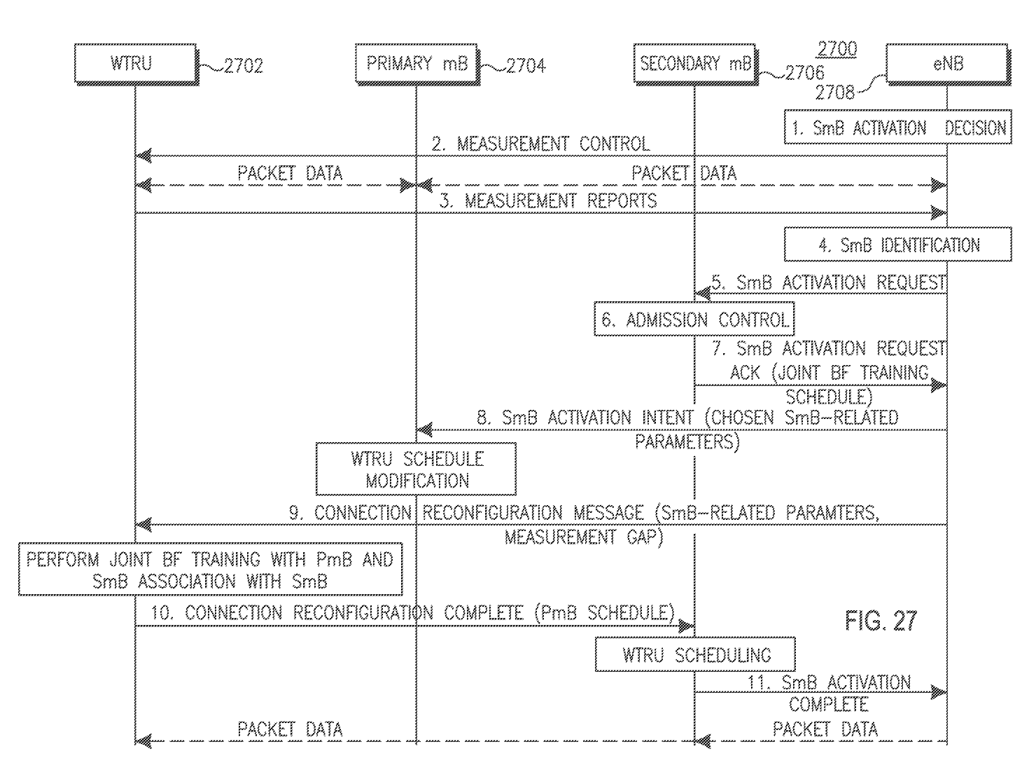

FIG. 27 shows the message sequence chart 2700 for SDM mode of simultaneous downlink transmission between a WTRU 2702, primary mB 2704, secondary mB 2706 and an eNB 2708. This is similar to the TDM mode, except that the WTRU 2702 needs to perform joint beamforming training with the primary and secondary mBs at the time proposed by the secondary mB 2706. Finally, following successful beamforming training and association, the secondary mB 2706 schedules downlink transmissions to the WTRU 2702 at the same time as the primary mB 2704. The WTRU 2702 employs separate beams emanating either from the same antenna array or separate arrays to communicate with the two mBs simultaneously.

Following link set-up between mB and WTRU 2702, the eNB 2708 decides to activate an additional downlink channel to WTRU 2702 through another mB (1). The original mB is henceforth caller primary mB 2704 and the additional mB is referred as secondary mB 2706. The decision may be based on several factors such as load balancing considerations, QoS requirements or as back-up in case of primary link failure.

The eNB 2708 configures UE measurement procedures according to area restriction information which was provided either at connection establishment or at the last TA update (2). The eNB 2708 may provide the WTRU 2702 with a list of possible neighboring mBs and their corresponding reference signal parameters or beacon transmission instants to aid measurements. The WTRU 2702 is triggered to send Measurement Reports by an already established reporting configuration (3).

The eNB 2708 identifies potential secondary mB based on Measurement Reports and RRM information (4). The eNB 2708 issues a SmB Activation Request message to the identified secondary mB 2706, passing necessary information to prepare secondary mB activation (5). Admission control may be performed by the secondary mB 2706 dependent on the received QoS information to increase the likelihood of a successful secondary mB 2706 activation (6).

The secondary mB 2706 sends the secondary mB Request Acknowledge to the eNB 2708 (7). This message may include proposed joint beamforming training schedule for WTRU 2702. The eNB 2708 generates the SmB Activation Intent message including secondary mB-related parameters and sends it to the primary mB 2704 (8). This triggers the primary mB 2704 to move any scheduled transmissions to the WTRU 2702 at the proposed beamforming time by the secondary mB 2706. If it is not possible to reschedule WTRU 2702 transmissions, it indicates this to the eNB 2708, which then requests the secondary mB 2706 to propose a different joint beamforming training schedule.

The eNB 2708 notifies WTRU 2702 of secondary mB-related parameters and measurement gap for beamforming training with secondary mB via Connection Reconfiguration message (9). The WTRU 2702 sends Connection Reconfiguration Complete message to secondary mB 2706 after successfully completing joint beamforming training and associating with it. It also includes its time allocations with the primary mB 2704 in the message (10). The secondary mB 2706 then chooses a different time allocation for the WTRU 2702. The secondary mB 2506 then sends a secondary mB Activation Complete message to the eNB 2708 to indicate successful activation of the downlink channel (11).

Described herein are considerations for the uplink based on the description stated hereinabove. For example, control information may be sent to both the mB and the eNB, the PHY and MAC feedback may go to the small cell and the eNB, the RLC feedback may go the eNB in the RLC PDU embodiment, the RLC feedback may go to the small cell and the eNB in the RLC SDU embodiment, and gaps in the uplink and downlink may need to be retuned. Based on WTRU capabilities, a WTRU may require gaps to allow retuning to activate/deactivate a mB carrier. The WTRU may be configured to perform retuning using autonomous gaps, using DRX, or alternatively, be configured with a gap duration with presumed interruption in the primary cell when retuning may be performed.

### Embodiments

1. A method for use in an underlay base station configured for high-rate, dual-band wireless communications system, the method comprising transmitting and receiving data to and from one or more wireless transmit/receive units (WTRUs) via underlay system access link, wherein the underlay system is non-standalone and control information is provided from an overlay system.

2. The method as in any of the preceding embodiments, further comprising: transmitting and receiving at least a portion of the data to or from an overlay base station via backhaul links.

3. The method as in any of the preceding embodiments, further comprising receiving control data from the overlay base station.

4. The method as in any of the preceding embodiments, further comprising embedding the data in a general packet radio service (GPRS) tunneling protocol (GTP) for transmission over the backhaul links.

5. The method as in any of the preceding embodiments, wherein a packet data convergence protocol (PDCP) entity and a radio link control (RLC) entity terminate in one of the overlay base station and an underlay gateway.

6. The method as in any of the preceding embodiments, wherein the data is split at a radio link control entity.

7. The method as in any of the preceding embodiments, wherein the data is split at a packet data convergence protocol (PDCP) entity.

8. The method as in any of the preceding embodiments, wherein the RLC entity maintains unacknowledged data or acknowledged data to be retransmitted during an underlay base station handover.

9. The method as in any of the preceding embodiments, further comprising local forwarding of non-transmitted data from the underlay base station to another underlay base station at handover.

10. The method as in any of the preceding embodiments, wherein the underlay base stations perform a complete data-plane protocol stack.

11. The method as in any of the preceding embodiments, wherein the underlay base station and one of the overlay base station and an underlay gateway buffer the data, further wherein the underlay base station receives data from one of the overlay base station and the underlay gateway after exchanging of packet data convergence protocol (PDCP) status packet data units (PDUs) to determine which PDCP PDUs should be transmitted to the underlay base station as a result of handover.

12. The method as in any of the preceding embodiments, further comprising receiving a configuration message including measurement configuration and buffer status reporting configuration.

13. The method as in any of the preceding embodiments, wherein the measurement configuration includes gap configuration and resources for performing intra-frequency and inter-frequency measurements, periodicity of measurements, white cell list, and black cell list.

14. The method as in any of the preceding embodiments, further comprising transmitting an underlay base station buffer status report triggered by at least one of establishment/reestablishment of connection with the overlay base station, underlay base station buffer availability changes by a predetermined threshold, free buffer availability is less than or equal to a configured threshold, periodic basis, WTRU handover, and detection/relief of congestion condition.

15. The method as in any of the preceding embodiments, further comprising transmitting a notification to support outbound handover of a WTRU, wherein the notification indicates at least one of: WTRU radio link condition below a threshold; underlay base station is congested; underlay base station needs to be turned off; sequence numbers of last acknowledged frame; sequence number of last unacknowledged frame; and WTRU statistics.

16. A method for wireless communications, the method comprising receiving at a wireless transmit/receive unit (WTRU) data plane information from a plurality of base stations.

17. The method as in any of the preceding embodiments, further comprising receiving at the WTRU control plane information for the plurality of base stations from a centralized base station.

18. The method as in any of the preceding embodiments, further comprising the plurality of base stations includes the centralized base station.

19. The method as in any of the preceding embodiments, wherein the plurality of base stations only transmits the data plane information.

20. The method as in any of the preceding embodiments, wherein transmission time interval (TTI) based scheduling is performed at the WTRU.

21. The method as in any of the preceding embodiments, wherein a radio link control (RLC) entity is terminated at the WTRU.

22. A method for wireless communications, the method comprising having a channel to a wireless transmit/receive unit (WTRU) through a millimeter wavelength (mmW) base station (mB).

23. The method as in any of the preceding embodiments, further comprising identifying another mB based on measurement information received from the WTRU to add another channel to the WTRU through the another mB.

24. The method as in any of the preceding embodiments, further comprising receiving an acknowledgement from the another mB including beamforming training information.

25. The method as in any of the preceding embodiments, further comprising transmitting a connection reconfiguration message to the WTRU regarding the another mB.

26. The method as in any of the preceding embodiments, further comprising receiving an activation complete message from the another mB based on successful allocation scheduling with respect to the mB.

27. The method as in any of the preceding embodiments, wherein the allocation scheduling is based on one of time division multiplexing, frequency division multiplexing and spatial division multiplexing.

28. A wireless communications system, comprising a cellular system including cellular base stations.

29. The system as in any of the preceding embodiments, further comprising a non-standalone system including non-standalone base stations, the non-standalone system underlying the cellular system.

30. The system as in any of the preceding embodiments, further comprising the cellular system configured to handle control plane operations for the non-standalone system.

31. The system as in any of the preceding embodiments, further comprising the non-standalone base stations configured to transmit and receive data with one or more wireless transmit/receive units (WTRUs) via non-standalone system access links.

32. The system as in any of the preceding embodiments, further comprising the non-standalone base stations configured to transmit and receive at least a portion of the data with the cellular base stations via backhaul links.

33. The system as in any of the preceding embodiments, further comprising wherein the data is embedded in a general packet radio service (GPRS) tunneling protocol (GTP) for transmission over the backhaul links.

34. The system as in any of the preceding embodiments, further comprising wherein a packet data convergence protocol (PDCP) entity and a radio link control (RLC) entity terminate in one of the cellular base station and non-standalone system gateway.

35. The system as in any of the preceding embodiments, further comprising wherein the data is split at a radio link control entity.

36. The system as in any of the preceding embodiments, further comprising wherein the data is split at a packet data convergence protocol (PDCP) entity.

37. The system as in any of the preceding embodiments, further comprising wherein the non-standalone system is a millimeter wave based system.

38. The system as in any of the preceding embodiments, further comprising wherein the non-standalone system base stations perform a complete data-plane protocol stack.

39. A method for use in a wireless transmit/receive unit, the method comprising transmitting data at one or more high frequencies.

40. The method as in any of the preceding embodiments, wherein the one or more high frequencies are millimeter wave (mmW) frequencies.

41. The method as in any of the preceding embodiments, wherein the transmitting data further includes transmitting at wide bandwidths.

42. The method as in any of the preceding embodiments, further comprising forming narrow beams for transmission.

43. The method as in any of the preceding embodiments, wherein the one or more high frequencies range from 28 GHz to 300 GHz.

44. The method as in any of the preceding embodiments, wherein the one or more high frequencies is 60 GHz.

45. The method as in any of the preceding embodiments, wherein the one or more high frequencies is 70 GHz, 80 GHz, or 90 GHz.

46. The method as in any of the preceding embodiments, further comprising carrier aggregation (CA) and support of flexible bandwidths.

47. The method as in any of the preceding embodiments, further comprising spectrum aggregation.

48. The method as in any of the preceding embodiments, further comprising receiving or transmitting on one or more component carriers (CCs).

49. The method as in any of the preceding embodiments, further comprising using a mmW base station (mB).

50. The method as in any of the preceding embodiments, further comprising providing a mmW access link to a WTRU.

51. The method as in any of the preceding embodiments, further comprising providing a mmW backhaul (BH) link to one or more mBs.

52. The method as in any of the preceding embodiments, wherein the BH link forms a multi-hop mesh network.

53. The method as in any of the preceding embodiments, wherein an evolved node B (eNB) controls data flow or provides control functions.

54. The method as in any of the preceding embodiments, further comprising using a mmW gateway (mGW).

55. The method as in any of the preceding embodiments, wherein the mGW is co-located with the mB or separate from the mB.

56. The method as in any of the preceding embodiments, further comprising connecting a WTRU to a cellular layer before receiving data on an mmW layer.

57. The method as in any of the preceding embodiments, wherein a cellular layer is used for mmW network control or connectivity and mobility management.

58. The method as in any of the preceding embodiments, wherein the mBs do not carry a full protocol stack.

59. The method as in any of the preceding embodiments, wherein the mBs do not continuously broadcast pilot information or system information.

60. The method as in any of the preceding embodiments, further comprising performing control plane functions at an evolved Node B (eNB) or mGW.

61. The method as in any of the preceding embodiments, further comprising providing control signaling via upper layers.

62. The method as in any of the preceding embodiments, further comprising carrying low throughput and delay-sensitive traffic at the cellular layer.

63. The method as in any of the preceding embodiments, further comprising performing idle mode mobility at the cellular layer.

64. The method as in any of the preceding embodiments, further comprising controlling the mBs via an eNB.

65. The method as in any of the preceding embodiments, further comprising using a small-cell cloud radio access network (RAN) architecture.

66. The method as in any of the preceding embodiments, further comprising at least one of using centralized RAN nodes, augmenting the centralized RAN nodes with a plurality of Remote Radio Units (RRUs) to provide extreme capacity and coverage, using centralized control plane and distributed data plane functions. or terminating control plane and higher data plane layers via the centralized RAN nodes.

67. The method as in any of the preceding embodiments, wherein the RRUs are 802.11xx access points (APs) or cellular units with physical layer (PHY) and medium access control layer (MAC) functionality.

68. The method as in any of the preceding embodiments, further comprising using a mesh backhaul to leverage a combination of wired and wireless links.

69. The method as in any of the preceding embodiments, further comprising establishing backhaul links dynamically or as-required by neighboring nodes.

70. The method as in any of the preceding embodiments, further comprising handling retransmissions at a radio link control (RLC) layer.

71. The method as in any of the preceding embodiments, further comprising providing control plane and data plane services at the centralized RAN node.

72. The method as in any of the preceding embodiments, further comprising integrating the mmW and cellular layers.

73. The method as in any of the preceding embodiments, further comprising coupling a MAC layer of the mmW with a MAC layer of a Long Term Evolution (LTE) system.

74. The method as in any of the preceding embodiments, wherein the mB is deployed alone.

75. The method as in any of the preceding embodiments, wherein the mB is co-located with a pico or femto cell node.

76. The method as in any of the preceding embodiments, wherein the mB is co-located with a relay node (RN).

77. The method as in any of the preceding embodiments, wherein the mB serves as a Remote Radio Equipment (RRE).

78. The method as in any of the preceding embodiments, further comprising terminating the mmW MAC sublayer at the mB.

79. The method as in any of the preceding embodiments, further comprising terminating the Packet Data Convergence Protocol (PDCP) sublayers and the RLC sublayers at the mGW or the eNB.

80. The method as in any of the preceding embodiments, wherein a control-plane protocol stack between the mB and eNB uses a mmW management application protocol (XM-AP) over SCTP/IP carried on a low throughput cellular link for a Xm-C interface.

81. The method as in any of the preceding embodiments, wherein a control-plane protocol stack between a mGW and eNB uses mGW management application protocol (M1-AP) over SCTP/IP carried on a wired link for an M1-C interface.

82. The method as in any of the preceding embodiments, wherein a control protocol stack between the WTRU and eNB and MME is the same as in a baseline LTE network.

83. The method as in any of the preceding embodiments, wherein a user-plane protocol stack between a WTRU and mB uses a mmW MAC and mmW physical layer.

84. The method as in any of the preceding embodiments, wherein RLC and PDCP layers reside in the WTRU and eNB, respectively.

85. The method as in any of the preceding embodiments, wherein the mB and the eNB use a mmW backhaul (BH) protocol over an Xm-U interface.

86. The method as in any of the preceding embodiments, wherein a control-plane protocol stack between mB and eNB uses a mmW management application protocol (XM-AP) over SCTP/IP carried on a low throughput cellular link for an Xm-C interface.

87. The method as in any of the preceding embodiments, wherein a user-plane protocol stack between the WTRU and mB uses mmW MAC and mmW physical layers for mB.

88. The method as in any of the preceding embodiments, wherein one or more of an LTE-based physical layer, MAC, RLC, or PDCP layer reside in the WTRU or eNB.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1-27. (canceled)

28. A method for use in an underlay base station configured for high-rate, dual-band wireless communications system, the method comprising:
transmitting and receiving data to and from one or more wireless transmit/receive units (WTRUs) via an underlay system access link, wherein the underlay system is non-standalone and control information is provided from an overlay system and wherein the underlay base station is linked to other underlay base stations to implement a mesh backhaul;
transmitting and receiving at least a portion of the data to or from an overlay base station via backhaul links; and
receiving control data from the overlay base station;
wherein the data is split at a packet data convergence protocol (PDCP) entity;
wherein the PDCP entity terminates in the overlay base station and a radio link control (RLC) entity terminates in the underlay base station.

29. The method of claim 28, further comprising:
local forwarding of non-transmitted data from the underlay base station to another underlay base station at handover.

30. The method of claim 28, wherein the underlay base stations perform a complete data-plane protocol stack.

31. The method of claim 28, wherein the underlay base station and one of the overlay base station and an underlay gateway buffer the data, further wherein the underlay base station receives data from one of the overlay base station and the underlay gateway after exchanging of packet data convergence protocol (PDCP) status packet data units (PDUs) to determine which PDCP PDUs should be transmitted to the underlay base station as a result of handover.

32. A wireless communications system, comprising:
a cellular system including cellular base stations;
a non-standalone system including non-standalone base stations, the non-standalone system underlying the cellular system;
the cellular system configured to handle control plane operations for the non-standalone system;
the non-standalone base stations configured to transmit and receive data with one or more wireless transmit/receive units (WTRUs) via non-standalone system access links and wherein the non-standalone base stations are linked to each other in a mesh backhaul; and
the non-standalone base stations configured to transmit and receive at least a portion of the data with the cellular base stations via backhaul links;
wherein the data is split at a packet data convergence protocol (PDCP) entity;
wherein the PDCP entity terminates in the overlay base station and a radio link control (RLC) entity terminates in the underlay base station.

33. The system of claim 32, wherein the non-standalone system is a millimeter wave based system.

34. The system of claim 32, wherein the non-standalone system base stations perform a complete data-plane protocol stack.

35. The system of claim 32, wherein the non-standalone base station and one of the cellular base station and a non-standalone gateway buffer the data, further wherein the non-standalone base station receives data from one of the cellular base station and the non-standalone gateway after exchanging of packet data convergence protocol (PDCP) status packet data units (PDUs) to determine which PDCP PDUs should be transmitted to the non-standalone base station as a result of handover.
